(19) United States
(12) Patent Application Publication
(10) Pub. No.: US 2026/0010111 A1
(43) Pub. Date: Jan. 8, 2026

(54) DEVELOPING CARTRIDGE

(71) Applicant: Zhuhai Dinghui Technology Co., Ltd., Zhuhai (CN)

(72) Inventors: Hangyu PENG, Nanping Zhuhai (CN); Xia LIU, Nanping Zhuhai (CN); Jiming TAN, Nanping Zhuhai (CN); Jinshi FAN, Nanping Zhuhai (CN); Wenyi FAN, Zhuhai (CN)

(73) Assignee: Zhuhai Dinghui Technology Co., Ltd., Zhuhai (CN)

(21) Appl. No.: 19/333,294

(22) Filed: Sep. 18, 2025

Related U.S. Application Data
(63) Continuation-in-part of application No. PCT/CN2024/082832, filed on Mar. 20, 2024.

(30) Foreign Application Priority Data
Mar. 20, 2023 (CN) 202320567889.6
Mar. 31, 2023 (CN) 202320714085.4
Apr. 6, 2023 (CN) 202320753604.8
Apr. 27, 2023 (CN) 202321018907.1
Aug. 31, 2023 (CN) 202322370543.X
Mar. 7, 2025 (CN) 202520403419.5
Mar. 26, 2025 (CN) 202520550232.8
Apr. 2, 2025 (CN) 202520623565.9
Apr. 25, 2025 (CN) 202520807620.X
Jun. 26, 2025 (CN) 202521335462.9

(51) Int. Cl. G03G 15/00; G03G 15/08; G03G 21/16

(52) U.S. Cl. CPC G03G 15/80; G03G 15/0808; G03G 15/0812; G03G 15/0891; G03G 21/1647

(57) ABSTRACT

The present application relates to a developing cartridge detachably mounted in an imaging apparatus provided with a first power output member and a second power output member. The developing cartridge includes a housing, a developing member and a toner feeding member, which are rotatably provided in the housing, a developing regulating member in contact with the developing member, and an electrically conductive member, wherein the first power output member outputs a voltage higher than a voltage outputted by the second power output member; the housing can accommodate a developing; the developing member rotates about a rotation axis extending in a first direction; a second direction intersects the first direction; one end of the second direction is directed to the front of the developing cartridge, and the other end of the second direction is directed to the rear of the developing cartridge; and the developing member is located at the front.

### RELATED APPLICATIONS

This application is a continuation-in-part of International Patent Application No. PCT/CN2024/082832, International Filing Date Mar. 20, 2024, entitled Developing Cartridge, which claims benefit of and priority to Chinese Patent Application No. 202320567889.6 filed Mar. 20, 2023; Chinese Patent Application No. 202320714085.4 filed Mar. 31, 2023; Chinese Patent Application No. 202320753604.8 filed Apr. 6, 2023; Chinese Patent Application No. 202321018907.1 filed Apr. 27, 2023; and Chinese Patent Application No. 202322370543.X filed Aug. 31, 2023; and this continuation-in-part application also claims priority to Chinese Patent Application No. 202520403419.5 filed Mar. 7, 2025; Chinese Patent Application No. 202520550232.8 filed Mar. 26, 2025; Chinese Patent Application No. 202520623565.9 filed Apr. 2, 2025; Chinese Patent Application No. 202520807620.X filed Apr. 25, 2025; Chinese Patent Application No. 202521335462.9 filed Jun. 26, 2025; all of which are incorporated herein by reference in their entireties.

### TECHNICAL FIELD

The present application relates to the field of electro-photographic imaging, in particular, to a developing cartridge removably mounted in an electro-photographic imaging apparatus.

### BACKGROUND ART

A developing cartridge is a component for containing developing. When the developing cartridge is provided in an electro-photographic imaging apparatus (hereinafter referred to as “apparatus”), it uses electrostatic imaging technology to render images or text desired by a user on an imaging medium. The developing cartridge is also provided with conductive assembly for receiving electric power from the imaging apparatus to ensure the normal operation of various functional components.

However, in existing imaging apparatuses, the conductive assembly is typically electrically connected to the surface of the distal end portion of the developing regulating member that faces the conductive assembly by means of direct abutment, so as to achieve power transmission. Although this structural design is relatively simple, the small contact area results in low power transmission efficiency, and it is prone to malfunctions due to poor contact, which affects the stability and reliability of the apparatus. In addition, the small contact area also limits the current-carrying capacity, which may cause problems such as local overheating or increased energy loss.

### SUMMARY

In view of this, the present application provides a developing cartridge, specifically, a developing cartridge comprising: a housing configured to extend along a first direction; a driving force receiving member provided at one end of the developing cartridge; and a developing roller being located at the housing in a rotatable manner and having a rotation axis parallel to the first direction; the developing cartridge further comprising: a developing regulating member fixedly mounted on the housing; and a conductive assembly for receiving electric power from an imaging apparatus and transmitting it to the developing regulating member; the developing roller comprises a developing roller shaft and a developing layer, the developing layer being farther from the rotation axis of the developing roller than a circumferential surface of the developing roller shaft; wherein the conductive assembly is not electrically connected to the developing roller shaft; the conductive assembly comprises a conductive member and a conducting member, the conducting member electrically connecting the conductive member and the developing regulating member; and the conducting member and the developing regulating member do not overlap in the first direction.

In some embodiments, in the first direction, projections of the conductive assembly and the developing regulating member do not overlap.

In some embodiments, the developing regulating member comprises a fixed body fixedly connected to the housing and a regulating body provided on the fixed body, and one end of the conducting member is electrically connected to the conductive member and the other end is electrically connected to the fixed body.

In some embodiments, in a second direction intersecting the first direction, a side where the developing roller is located is a front of the developing cartridge, and an opposite side to the developing roller is a rear; the conductive member is configured to extend substantially along the second direction, and the conducting member is configured to extend along the first direction.

In some embodiments, in the second direction, an end of the conducting member for connecting to the fixed body is provided on a side of the fixed body remote from the regulating body.

In some embodiments, the fixed body includes a second flat portion fixedly connected to the regulating body, and in the second direction, the conducting member is configured to contact an inner side of the second flat portion.

In some embodiments, a third direction of the developing cartridge intersects both the first direction and the second direction, with one end of the third direction pointing upward of the developing cartridge and the other end pointing downward; in the third direction, the conducting member is provided above the fixed body.

In some embodiments, the fixed body further comprises a first flat portion and a bent portion connecting the first flat portion and the second flat portion; in the third direction, the conducting member is configured to contact an outer side of the first flat portion.

In some embodiments, the first flat portion and the second flat portion are at a right angle.

In some embodiments, in the second direction or the third direction, at least a part of the conducting member overlaps with a projection of the developing regulating member.

In some embodiments, the conductive member and the conducting member are provided as separate components, and an end of the conducting member for connecting to the fixed body has a bending part.

In some embodiments, the conducting member is provided with a bending portion, and the bending portion is connected to the conductive member.

In some embodiments, at least a part of the conducting member is provided between the developing regulating member and the housing, and the conducting member is provided with an elastic portion that abuts against the housing.

In some embodiments, the developing roller shaft is configured as an insulating shaft body.

In some embodiments, the developing layer comprises an insulating layer and a conductive layer, the insulating layer is provided between the developing roller shaft and the conductive layer, and the developing roller shaft is configured as a conductive shaft.

In some embodiments, the insulating layer is configured as an insulating coating sprayed on a radially outer surface of the developing roller shaft or on a radially inner side of the conductive layer, and the developing roller shaft is configured as a metal shaft.

In some embodiments, the developing cartridge comprises a powder feeding roller for conveying developer to the developing roller, the powder feeding roller being rotatably mounted in the housing, and the conductive assembly is in electrical contact with both the developing regulating member and the powder feeding roller; wherein both the developing regulating member and the powder feeding roller are in contact with the developing layer, and at least one of the developing regulating member and the powder feeding roller supplies electric power to the developing layer.

In some embodiments, the developing cartridge comprises a right bracket for supporting the developing roller, at least a part of the conductive assembly being provided at the right bracket; along the first direction, at least a part of the conductive assembly is flush with or extends beyond a farthest end of the right bracket.

In some embodiments, the developing cartridge comprises an engaging protrusion provided at an end of the housing close to the right bracket for receiving a separating force applied by the imaging apparatus; wherein a gap is formed between the conductive assembly and the engaging protrusion.

In some embodiments, in the second direction, a projection of the conductive assembly at least partially overlaps with a projection of the engaging protrusion.

The present application provides a developing cartridge to solve the above technical problems.

### BRIEF DESCRIPTION OF THE DRAWINGS

FIGS. 1A, 1B and 1C are perspective views of a developing cartridge involved in Embodiment 1 of the present application.

FIG. 1D is a structural schematic diagram of the developing roller, the second seal, and the housing in the developing cartridge involved in Embodiment 1 of the present invention after being separated.

FIG. 2 is an exploded perspective view of some components of the developing cartridge involved in Embodiment 1 of the present application.

FIG. 3 is a sectional view of an A-A cross-section in FIG. 1A.

FIG. 4A is a side view of the developing cartridge involved in Embodiment 1 of the present application, as viewed from a drive end in a first direction with a left end cap hidden.

FIG. 4B is a side view of the developing cartridge involved in Embodiment 1, as viewed from below in an up-down direction with end caps on both sides hidden.

FIG. 5A is a side view of a conductive assembly of the developing cartridge involved in Embodiment 1 of the present application coupled with a power output member in an imaging apparatus, as viewed in a third direction.

FIG. 5B is a side view of the conductive assembly of the developing cartridge involved in Embodiment 1 of the present application coupled with the power output member in the imaging apparatus, as viewed in a first direction.

FIG. 6 is a schematic diagram of a state after a conductive assembly of a developing cartridge involved in Embodiment 2 of the present application is separated from a housing.

FIG. 7 is a side view of the developing cartridge involved in Embodiment 2 of the present application, with the conductive assembly provided, as viewed in a third direction.

FIG. 8 is a schematic diagram of a state after a conductive assembly of a developing cartridge involved in Embodiment 3 of the present application is separated from a housing.

FIG. 9A is a side view of the developing cartridge involved in Embodiment 3 of the present application, with the conductive assembly provided, as viewed in a third direction.

FIG. 9B is a perspective view of a first type of power enhancement member provided on an outer surface of a developing roller in the developing cartridge involved in Embodiment 3 of the present application.

FIG. 9C is a perspective view of a second type of power enhancement member provided on the outer surface of the developing roller in the developing cartridge involved in Embodiment 3 of the present application.

FIG. 9D is a perspective view of a third power enhancement member provided on the outer surface of the developing roller in the developing cartridge involved in Embodiment 3 of the present application.

FIG. 10 is a schematic diagram of a state after a conductive assembly of a developing cartridge involved in Embodiment 4 of the present application is separated from a housing.

FIG. 11 is a side view of the developing cartridge involved in Embodiment 4 of the present application, with the conductive assembly provided, as viewed in a third direction.

FIG. 12 is a schematic diagram of a state after a conductive assembly of a developing cartridge involved in Embodiment 5 of the present application is separated from a housing.

FIG. 13 is a side view of the developing cartridge involved in Embodiment 5 of the present application, with the conductive assembly provided, as viewed in a third direction.

FIG. 14 is a schematic diagram of a state after a conductive assembly of a developing cartridge involved in Embodiment 6 of the present application is separated from a housing.

FIG. 15 is a side view of the developing cartridge involved in Embodiment 6 of the present application, with the conductive assembly provided, as viewed in a third direction.

FIG. 16 is a schematic diagram of a state after a conductive assembly of a developing cartridge involved in Embodiment 7 of the present application is separated from a housing.

FIG. 17 is a perspective view of a developing roller shaft in a developing cartridge involved in Embodiment 8 of the present application.

FIG. 18 is a schematic diagram of an overall structure of a developing cartridge involved in Embodiment 9 of the present application.

FIG. 19 is a schematic diagram of an overall structure of the developing cartridge involved in Embodiment 9 of the present application with a right bracket hidden.

FIG. 20 is a schematic diagram of an overall structure of the developing cartridge involved in Embodiment 9 of the present application with part of a housing hidden.

FIG. 21 is an exploded structural diagram of the developing cartridge involved in Embodiment 9 of the present application from another perspective.

FIG. 22 is a schematic diagram of an overall structure of a developing cartridge involved in Embodiment 10 of the present application.

FIG. 23 is a schematic diagram of an overall structure of the developing cartridge involved in Embodiment 10 of the present application with a right bracket hidden.

FIG. 24 is a schematic diagram of an overall structure of a developing cartridge involved in Embodiment 11 of the present application.

FIG. 25 is an exploded structural diagram of the developing cartridge involved in Embodiment 11 of the present application from another perspective.

FIG. 26 is a schematic diagram of an overall structure of a developing cartridge involved in Embodiment 12 of the present application.

FIG. 27 is an exploded structural diagram of the developing cartridge involved in Embodiment 12 of the present application from another perspective.

FIG. 28 is a schematic diagram of an overall structure of a developing cartridge involved in Embodiment 13 of the present application.

FIG. 29 is an exploded structural diagram of the developing cartridge involved in Embodiment 13 of the present application from another perspective.

FIG. 30 is a schematic diagram of an overall structure of a developing cartridge involved in Embodiment 14 of the present application.

FIG. 31 is a perspective view of a developing cartridge (including a first constituent part and a second constituent part) involved in the present application.

FIGS. 32 and 33 are perspective views of a chip assembly mounting section in an imaging apparatus compatible with a developing cartridge involved in the present application.

FIG. 34 is a side view of the chip mounting section viewed in a first direction.

FIG. 35 is a schematic diagram of an overall structure of a developing cartridge involved in Embodiment 15 of the present application.

FIG. 36 is a schematic diagram of an overall structure of another embodiment of the developing cartridge involved in Embodiment 15 of the present application.

FIG. 37 is a schematic diagram of an overall structure of a developing cartridge involved in Embodiment 16 of the present application.

FIG. 38 is a schematic diagram of an overall structure of the developing cartridge involved in Embodiment 16 of the present application from another perspective.

FIG. 39 is a schematic diagram of an overall structure of a developing cartridge involved in Embodiment 17 of the present application.

FIG. 40 is a schematic diagram of an overall structure of a developing cartridge involved in Embodiment 18 of the present application.

FIG. 41 is a schematic view of an overall structure of the developing cartridge involved in FIG. 40 with a first threaded fastener and a second threaded fastener hidden.

FIG. 42 is a schematic diagram of an overall structure of a developing cartridge involved in Embodiment 19 of the present application.

FIG. 43 is a schematic diagram of an overall structure of the developing cartridge involved in Embodiment 19 of the present application from another perspective.

FIG. 44 is a schematic diagram of an overall structure of the developing cartridge involved in Embodiment 19 of the present application from yet another perspective.

FIG. 45 is a schematic diagram of an overall structure of a developing cartridge involved in Embodiment 20 of the present application.

FIG. 46 is an exploded structural diagram of the developing cartridge shown in FIG. 45.

FIG. 47 is a schematic diagram of an overall structure of another variant of Embodiment 20 of the present application.

FIG. 48 is a schematic diagram of an overall structure of the developing cartridge shown in FIG. 47 with a right bracket hidden.

FIG. 49 is a schematic diagram of an overall structure of a developing cartridge involved in Embodiment 21 of the present application.

FIG. 50 is a schematic diagram of an overall structure of another variant of Embodiment 21 of the present application.

FIG. 51 is an overall structural schematic diagram of the developing cartridge according to Embodiment 22 of the present invention.

FIG. 52 is a front view of the developing roller, the developing regulating member, and the conductive assembly in Embodiment 22 of the present invention, viewed along the first direction.

FIG. 53 is a front view of the developing roller, the developing regulating member, and the conductive assembly in Embodiment 22 of the present invention, viewed along the second direction.

FIG. 54 is a front view of the developing roller, the developing regulating member, and the conductive assembly in Embodiment 22 of the present invention, viewed along the third direction.

### DETAILED DESCRIPTION OF THE EMBODIMENTS

Embodiments of the present application are described in detail below with reference to the accompanying drawings. It should be understood that the various embodiments described below are not isolated from each other, and those skilled in the art may combine structures in the following embodiments with each other according to design needs.

### Embodiment 1

### [Overall Structure of Developing Cartridge]

A developing cartridge 1 includes a housing 2 forming a developing cavity 10, and a rotating member 3 rotatably mounted in the housing 2. The rotating member 3 may be, for example, a developing roller 31 for conveying the developer outward, or may be a powder feeding roller 32 arranged adjacent to the developing roller 31 and configured to convey developer to the developing roller 31, or may be a stirring member 33 located in the developing cavity 10. The stirring member 33 stirs the developer in the developing cavity 10, which on the one hand may prevent the developer from clumping, and on the other hand serves to convey the developer towards the powder feeding roller 32. The developing cartridge further includes a handle 23 connected to the housing 2. The developing roller 31 and the handle 23 are respectively located at the two ends of the housing 2 in a mounting direction.

The developing roller 31 rotates about a first axis L1, and the housing 2 extends in a first direction parallel to the first axis L1. The developing cartridge 1 also has a second direction that intersects the first direction, and a third direction that intersects both the first direction and the second direction. Preferably, the first direction, the second direction, and the third direction are perpendicular to each other, wherein one end 51 of the first direction points toward a left side of the developing cartridge, and the other end 52 of the first direction points toward a right side of the developing cartridge; one end 53 of the second direction points toward a front side of the developing cartridge, and the other end 54 of the second direction points toward a rear side of the developing cartridge; the developing roller 31 is located at the front side of the developing cartridge, and a side opposite to a side where the developing roller 31 is located is the rear side of the developing cartridge; one end 55 of the third direction points toward an upper side of the developing cartridge, and the other end 56 of the third direction points toward a lower side of the developing cartridge.

In the following, an end of the left side of the developing cartridge is a drive end, and an end of the right side of the developing cartridge is a conductive end. A member to be detected 9 in an apparatus is provided on the right side of the developing cartridge, and thus, the right end of the developing cartridge may also be referred to as a detection end. The developing cartridge 1 further includes a detection apparatus 6. The detection apparatus 6 has a portion located at the drive end, another portion located at the detection end, and a portion located between the drive end and the detection end. A driving force transmission assembly 4 is configured to transmit a driving force received by a driving force receiving member 41 provided at the drive end to the rotating member 3 and the detection apparatus 6.

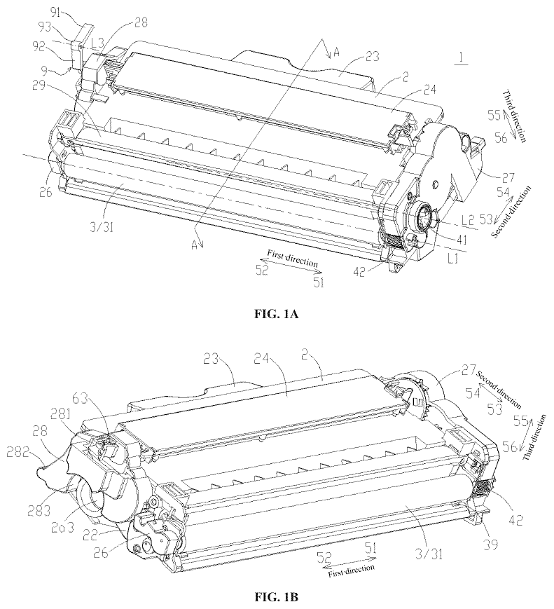

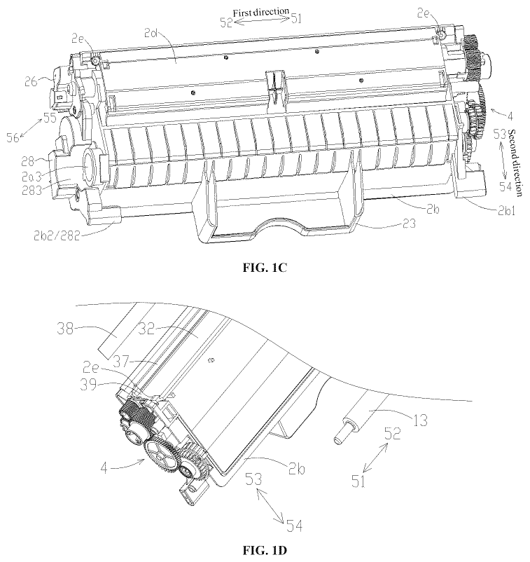

The housing 2 has a left surface 21 that faces the left side, a right surface 22 that faces the right side, and a left end cap 27 and a right end cap 28 that are respectively coupled to the housing 2, wherein the left end cap 27 is opposite the left surface 21, and the right end cap 28 is opposite the right surface 22. A portion of the driving force receiving member 41 is exposed to the outside from the left end cap. A portion of the detection apparatus 6 is exposed to the outside from the right end cap 28. As shown in FIG. 1B, the right end cap 28 has an exposure opening 281. The size of the exposure opening 281 is larger than that of a component (hereinafter referred to as an actuating assembly 63) of the detection apparatus 6 located at the detection end. Further, the developing cartridge 1 also includes a developing regulating member 29 fixedly mounted to the housing 2, a conductive assembly 26 coupled to the housing 2, and a chip assembly 11 mounted to one of the housing 2, the left end cap 27, and the right end cap 28. The chip assembly 11 may be a chip provided with a substrate 71, electrical contacts 72 (as shown in FIG. 4B), and a storage unit, or may be a chip provided with a substrate, electrical contacts, a storage unit, and a movable member configured to be movably connected to the electrical contacts. The conductive assembly 26 is located at the detection end, and configured to receive electric power from the apparatus and supply the electric power to the developing roller 31.

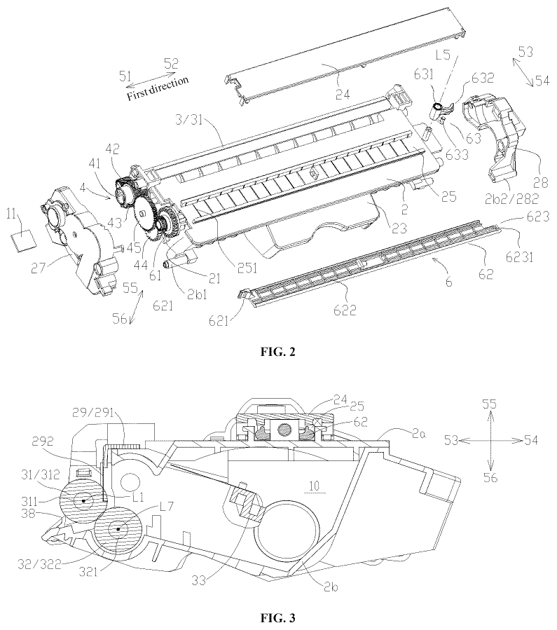

During operation of the developing cartridge 1, the developing roller 31 needs to be opposite a photosensitive drum outside the developing cartridge, so that the developing on a surface of the developing roller 31 may reach a surface of the photosensitive drum to achieve development. To this end, it is advantageous for the developing cartridge 1 to be urged toward the photosensitive drum. As shown in FIGS. 1C and 2, the developing cartridge 1 further includes a first urged portion 2b1 and a second urged portion 2b2 that are provided at the rear side of the developing cartridge, wherein the first urged portion 2b1 is located on a left side of the housing 2, and the second urged portion 2b2 is located on a right side of the housing 2. Specifically, the first urged portion 2b1 is formed to protrude leftward from the left side of the housing 2, and the second urged portion 2b2 is formed to protrude leftward from the right end cap 28. That is, along the first direction, the first urged portion 2b1 and the second urged portion 2b2 both protrude in the same direction. Thus, the first urged portion 2b1 and the second urged portion 2b2 may also both protrude rightward. Such a structure is advantageous for miniaturization of the developing cartridge 1.

Generally, the photosensitive drum is provided in a drum frame, and the developing cartridge 1 may be removably mounted to the drum frame, and then the combination of the developing cartridge 1 and the drum frame is removably mounted to the apparatus; or the photosensitive drum is pre-provided in the apparatus, and the developing cartridge 1 is directly mounted removably to the apparatus. The first direction, the second direction, and the third direction described above are all defined with reference to a posture of the developing cartridge 1 after being mounted to the drum frame or the apparatus.

### [Right End Cap]

Along the second direction, the right end cap 28 is located on a rear side of the conductive assembly 26. A portion 282 of the right end cap 28 is formed as the second urged portion 2b2. A portion of the actuating assembly 63 is exposed from the exposure opening 281. When viewed in the first direction, the right end cap 28 does not overlap with a powder filling port 2a3 provided at the detection end. When the developing inside the developing cartridge is exhausted, a user may directly replenish the developing into the developing cartridge without removing the right end cap 28. In the third direction, the powder filling port 2a3 is located below the actuating assembly 63. As to the actuating assembly 63 provided in a protruding shape, when the user replenishes the developing into the developing cartridge, not only does it not interfere with the actuating assembly 63, but also the actuating assembly 63 and the powder filling port 2a3 may be observed by the user at the same time, thereby substantially reducing the probability of damage to the actuating assembly 63. Along the first direction, the powder filling port 2a3 is located between the second urged portion 2b2/282 and the conductive assembly 26.

### [Paper Guide Plate]

During operation of the developing cartridge 1, along the third direction, an imaging medium (e.g., printing paper) passes through the developing cartridge in the second direction from underneath the developing cartridge 1. In order to keep a movement path of the imaging medium stable, the developing cartridge 1 further includes a paper guide plate 2d provided underneath the housing 2. As shown in FIG. 1C, the paper guide plate 2d has a continuous surface extending substantially along the first direction and the second direction. Preferably, a surface of the paper guide plate 2d is a smooth surface. More preferably, along the first direction, the surface of the paper guide plate 2d is planar, and along the second direction, the surface of the paper guide plate 2d is a plurality of planar surfaces provided adjacent to each other, with each two adjacent planar surfaces intersecting in a line parallel to the first direction.

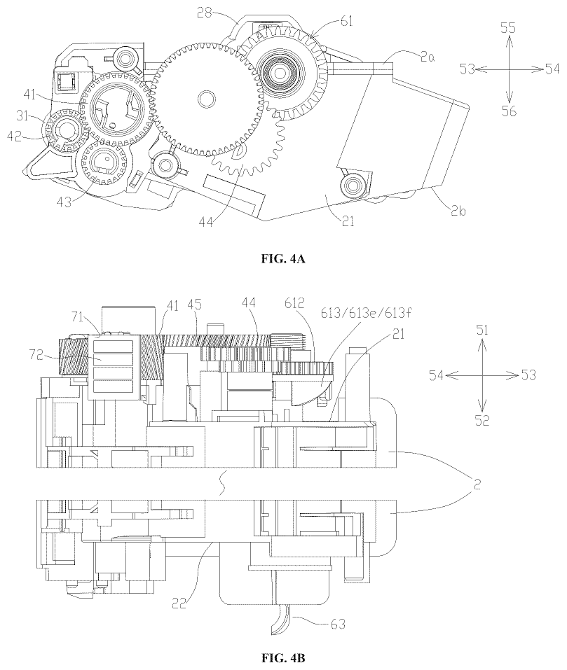

In practice, in order to prevent leakage of the developing, as shown in FIG. 1B, along the first direction, the developing cartridge 1 further includes first sealing members 39 located at both longitudinal ends of the developing roller 31, and as shown in FIG. 3, along the second direction, the developing cartridge further includes a second sealing member 38 and a third sealing member 37 that are at least partially located on a front side of the developing roller 31. The first sealing members 39 are preferably felt/sponge configured to seal against the longitudinal ends of the developing roller 31. The second sealing member 38 is preferably a sheet-like sealing member configured to contact and seal against a circumferential surface of the developing roller 31. The third sealing member 37 is preferably sponge configured to contact and seal against the circumferential surface of the developing roller 31.

In the prior art, the first sealing members 39, the second sealing member 38, and the third sealing member 37 are all bonded to the housing 2 by pasting double-sided tape on one side. On the one hand, such a method is not favorable to automated production, and the first sealing members 37 located at the two longitudinal ends of the developing roller are subjected to a large tensile force, resulting in the first sealing members being torn apart. On the other hand, such a method has low installation precision, resulting in a poor sealing effect. In the present application, adhesive is injected on a side of the first sealing member 39/the second sealing member 38 facing the housing to achieve precise bonding between the first sealing member 39/the second sealing member 38 and the housing 2. As shown in FIG. 1C, two injection ports 2e are further provided on a lower side of the housing 2. Each injection port 2e is at least in communication with one of the first sealing members 39 and the second sealing member 38, such that the adhesive injected through the injection port 2e may smoothly reach the side of the first sealing members 39 and/or the second sealing member 38 facing the housing 2. The injection of the adhesive through the injection ports 2e not only may increase the bonding strength between the sealing members and the housing 2, but also may effectively fill gaps between the first sealing members 39, the second sealing member 38, and the third sealing member 37, as well as gaps between the sealing members and the housing 2. In addition, the injection of the adhesive through the injection ports 2e allows for automated production of the developing cartridge 1. Preferably, along the first direction, the paper guide plate 2d is located between the two injection ports 2e to prevent the injection ports 2e from being obstructed by the paper guide plate 2d. Further, along the first direction, the paper guide plate 2d is located between the conductive assembly 26 and the chip assembly 11 to prevent the chip assembly 11 from being influenced by the conductive assembly 26.

### [Chip Assembly]

As shown in FIG. 31, the chip assembly 11 includes a chip holder 1111 and a chip 1112. The chip 1112 has electrical contacts 72 for electrical connection/electrical contact with a contact pin 403 in the imaging apparatus. At least the electrical contacts 72 are supported by the chip holder 1111. Further, the chip 1112 further includes a substrate 71. The electrical contacts 72 may be provided on the substrate 71, or may be provided separately from the substrate 71. An example in which the electrical contacts 72 are provided on the substrate 71 is used in the following description.

Further as shown in FIG. 31, the chip holder 1111 includes a first constituent part 1113 and a second constituent part 1114, wherein along the third direction, at least a portion of the first constituent part 1113 is located above the second constituent part 1114, and the electrical contacts 72 are supported by the first constituent part 1113. The electrical contacts 72 may be directly supported by the first constituent part 1113, or may be indirectly supported by the first constituent part. The first constituent part 1113 is configured to be immovable with respect to the housing 2, and the second constituent part 1114 is configured to be movable with respect to the housing 2, i.e., the first constituent part 1113 is fixedly provided with respect to the housing 2, and the second constituent part 1114 is movably provided with respect to the housing. The first constituent part 1113 is connected directly or indirectly to the housing 2. For example, the first constituent part 1113 is formed to directly extend from the housing 2. Alternatively, the first constituent part 1113 is formed to extend from a component (e.g., the left end cap 27) that is fixedly connected to the housing 2. In this case, the first constituent part 1113 is fixed with respect to the housing 2 as the component is fixedly connected to the housing 2.

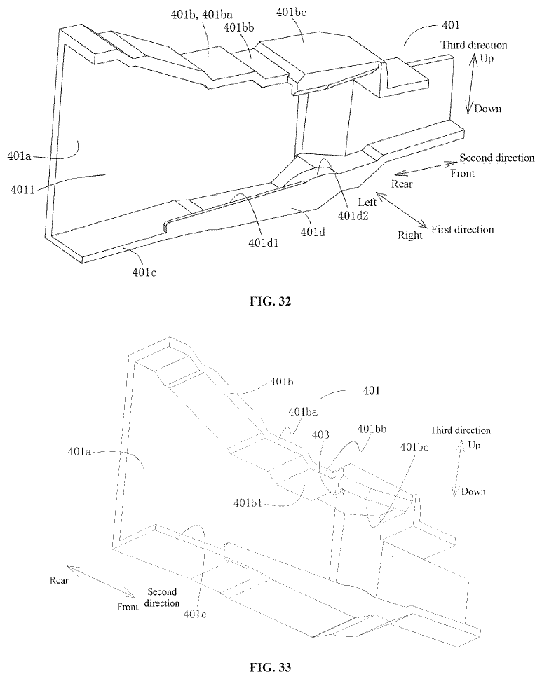

Referring to FIGS. 32 and 33 in combination, a chip assembly mounting section 401 in the imaging apparatus includes an apparatus first side wall 401a, an apparatus upper wall 401b, and an apparatus lower wall 401c. The apparatus first side wall 401a, the apparatus upper wall 401b, and the apparatus lower wall 401c enclose an accommodating space 4011 that may accommodate the chip assembly 11. Further, the chip assembly mounting section 401 further includes an apparatus second side wall 401d connected to the apparatus lower wall 401c. The apparatus first side wall 401a and the apparatus second side wall 401d are provided opposite each other in the first direction. The apparatus upper wall 401b and the apparatus lower wall 401c are provided opposite each other in a third direction. The contact pin 403 is provided on the apparatus upper wall 401b.

Along a rear-to-front direction, the apparatus upper wall 401b is sequentially provided with an upper front wall 401ba, an upper middle wall 401bb and an upper rear wall 401bc, and the apparatus second side wall 401d is sequentially provided with a lower front wall 401d1 and a lower rear wall 401d2. Along the third direction, the lower rear wall 401d2 is closer to the apparatus upper wall 401b than the lower front wall 401d1. The apparatus upper wall 401b has an upper wall bottom surface 401b1 facing the accommodating space 4011. According to a shape change of the apparatus upper wall 401b, along the third direction, a distance from the upper wall bottom surface 401b1 to the apparatus lower wall 401c changes. As shown in FIG. 34, a distance from the upper front wall 401ba to the apparatus lower wall 401c (a distance from an upper wall bottom surface 401b corresponding to the upper front wall 401ba to the apparatus lower wall 401c) is h1, a distance from the upper middle wall 401bb to the apparatus lower wall 401c (a distance from an upper wall bottom surface 401b corresponding to the upper middle wall 401bb to the apparatus lower wall 401c) is h2, and a distance from the upper back wall 401bc to the apparatus lower wall 401c (a distance from an upper wall bottom surface 401b corresponding to the upper back wall 401bc to the apparatus lower wall 401c) is h3, which satisfies h1>h2 and h3>h2, that is, along the mounting direction of the developing cartridge 1 (the rear-to-front direction), a portion of the accommodating space 4011 decreases and then increases in the dimension of the third direction.

Further as shown in FIG. 34, a range in which the upper front wall 401ba extends in the second direction corresponds to a first region S1 in the third direction, a range in which the upper middle wall 401bb extends in the second direction corresponds to a second region S2 in the third direction, and a range in which the upper rear wall 401bc extends in the second direction corresponds to a third region S3 in the third direction. According to the foregoing description, a height of the first region S1 in the third direction is the h1, a height of the second region S2 in the third direction is the h2, and a height of the third region S3 in the third direction is the h3.

In this embodiment, at least a portion of the second constituent part 1114 may be made of an elastic material, or an elastic member may be provided between the second constituent part 1114 and the first constituent part 1113, such that the second constituent part 1114 may be movable with respect to the housing 2 under the action of an external force.

Further, as shown in FIG. 31, the developing cartridge 1 further includes a left guide protrusion 1115 and a right guide protrusion (not shown) that are symmetrically provided in the first direction. During installation of the developing cartridge 1 toward a drum cartridge, or during installation of the developing cartridge 1 toward the imaging apparatus, at least one of the left guide protrusion 1115 and the right guide protrusion guides the developing cartridge 1 to ensure that the developing cartridge 1 moves along a predetermined mounting trajectory. In a state where the developing cartridge 1 is mounted to the drum cartridge, or in a state where the developing cartridge 1 is mounted to the imaging apparatus, the left guide protrusion 1115 and right guide protrusion respectively cooperate with corresponding mounting grooves. The mounting grooves may be provided in the drum cartridge or in the imaging apparatus. Finally, the developing cartridge 1 is positioned in the drum cartridge or in the imaging apparatus.

Preferably, along the first direction, the left guide protrusion 1115 and right guide protrusion are respectively located at two ends of the housing 2. The two may be formed on the housing 2, or may be formed on the end caps that are respectively located at the two ends of the housing 2, as long as the left guide protrusion 1115 and right guide protrusion formed achieve the above-described guiding and positioning functions.

In a state where a process cartridge is being initially provided to the imaging apparatus, a door cover of the imaging apparatus is not yet closed, the chip assembly 11 is located in the first region S1, and the second constituent part 1114 abuts against the lower front wall 401d1. At this time, the second constituent part 1114 may be in an elastically deformed state, or may be in a natural state. As the process cartridge continues to be provided forward in the second direction, the chip assembly 11 arrives at the second region S2. Due to h2<h1, at this time, the second constituent part 1114 begins to undergo elastic deformation, or the second constituent part 1114 squeezes upward the elastic member located between the first constituent part 1113 and the second constituent part 1114, and overall, the second constituent part 1114 moves upward with respect to the housing 2. When the chip assembly member 11 arrives at the third region S3, due to h2 being less than h3, under the action of an elastic force released by the second constituent part 1114, or under the action of an elastic force released by the elastic member between the second constituent part 1114 and the first constituent part 1113, the developing cartridge 1 starts to rotate around the left guide protrusion 1115 and the right guide protrusion, the chip assembly 11 moves upward, and finally, the electrical contacts 72 come into contact with the contact pin 403, and under the action of the elastic force, the electrical contacts 72 and the contact pin 403 remain in contact. Preferably, an angle of rotation of the developing cartridge 1 is in the range of 0° to −20°, preferably 5° to −15°.

Preferably, under the action of the elastic force, a rotational axis of the developing cartridge 1 coincides with a rotational axis L1 of a developing roller 21.

Regardless of the elastic force released by the second constituent part 1114 or the elastic force released by the elastic member between the second constituent part 1114 and the first constituent part 1113 may be regarded as an embodiment of a lifting force, and the lifting force is generated by the second constituent part 1114 during movement with respect to the housing 2.

When the chip assembly 11 arrives at the third region S3, the second constituent part 1114 may also abut against the lower rear wall 401d2, such that the first constituent part 1113 may receive a greater elastic force, the developing cartridge 1 may be held more stably, and accordingly, the electrical contacts 72 and the contact pin 403 may be maintained more stably in a contact state.

In some embodiments, the elastic force may also move upward the process cartridge as a whole, thereby bringing the electrical contacts 72 into contact with the contact pin 403.

In some embodiments, an axis about which the developing cartridge rotates around the left guide protrusion 1115 and the right guide protrusion coincides with the rotational axis of the developing roller.

In some embodiments, when the elastic force moves upward the process cartridge as a whole, the process cartridge rotates around the left guide protrusion 1115 and the right guide protrusion, thereby bringing the electrical contacts 72 into contact with the contact pin 403.

In some embodiments, the elastic force may also move upward the drum cartridge, which then drives the developing cartridge 1 to move upward, thereby bringing the electrical contacts 72 into contact with the contact pin 403.

In some embodiments, the chip assembly 11 may be provided in the imaging apparatus independently of the developing cartridge 1, or provided in the imaging apparatus independently of the developing cartridge 1 and the drum frame. Moreover, the chip assembly 11 may be separated from the developing cartridge 1/drum frame when being provided in the imaging apparatus, which may avoid the problem of interference between the chip assembly 11 and the developing cartridge when the developing cartridge 1 is provided in the imaging apparatus, as compared with the prior art in which the chip assembly 11 is mounted on the developing cartridge.

### [Driving Force Transmission Assembly]

A driving force transmission assembly 4 includes at least one of a driving force receiving member 41, a developing roller driving member 42, a powder feeding roller driving member 43, and a stirring member driving member 44. In the case where the stirring member driving member 44 is provided, the driving force transmission assembly 4 further includes an idler pulley 45 located between the driving force receiving member 41 and the detection apparatus 6. The driving force receiving member 41 transmits a driving force through the idler pulley 45 to the stirring member driving member 44, and then the stirring member driving member 44 transmits the driving force to the detection apparatus 6. In some embodiments, the driving force transmitted to the detection apparatus 6 may also be directly originated from any one of the driving force receiving member 41, the developing roller driving member 42, the powder feeding roller driving member 43, and the idler pulley 45. In an implementable manner, the stirring member 33 may be configured to rotate about an axis parallel to the first direction, or may be configured to reciprocate in a direction substantially parallel to the second direction. A driving force transmission mode between the driving members may be gear meshing transmission, belt transmission, friction wheel transmission, etc. Preferably, each driving force transmission assembly 4 is configured as a gear.

The driving force receiving member 41 rotates about a second axis L2 parallel to the first direction. The member to be detected 9 is configured as a rod rotatable around a third axis L3 parallel to the first direction. The member to be detected includes a rotation portion 93, as well as a first rod 91 and a second rod 92 connected to the rotation portion 93, wherein the second rod 92 is configured to interact with the detection apparatus 6, and the first rod 91 is configured to be detected by the apparatus.

### [Detection Apparatus]

The detection apparatus 6 includes a drive assembly 61 provided at the drive end, an actuating assembly 63 provided at the detection end, and a transmission member 62 located between the drive assembly 61 and the actuating assembly 63. After receiving the driving force, the drive assembly 61 drives the transmission member 62 to move in a direction not perpendicular to the first direction, thereby forcing the actuating assembly 63 to interact with the member to be detected 9. The actuating assembly 63 may nudge the member to be detected 9 in a rotation or translation manner, and the transmission member 62 for driving the actuating assembly 63 may also move in a rotation or translation manner. Preferably, a movement direction of the transmission member 62 is parallel to the first direction. More preferably, the transmission member 62 reciprocates in a direction parallel to the first direction. In this way, components such as gears, ratchets and the like for transmitting the driving force may be omitted at the detection end of the developing cartridge, or the number of components such as gears, ratchets and the like for transferring the driving force may be reduced, so the structure of the detection end is simplified, and during assembly of the developing cartridge, attention only needs to be focused on the assembly at the drive end.

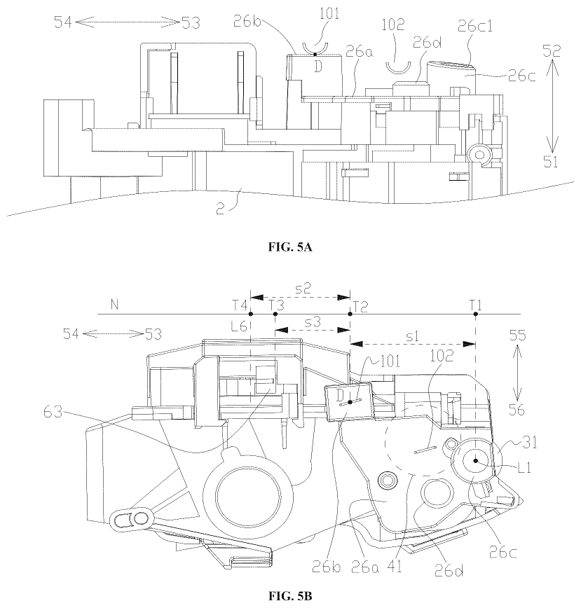

Along the second direction (an installation and removal direction of the developing cartridge 1), the imaging apparatus is provided with a first power output member 101 and a second power output member 102 that are spaced apart from each other. In an existing developing cartridge, the first power output member 101 is configured to supply electric power to the powder feeding roller 32, and the second power output member 102 is configured to supply electric power to the developing roller 31. In a forward direction (the front side 53 of the developing cartridge), the second power output member 102 is located downstream of the first power output member 101. As shown in FIG. 5A, when the developing cartridge 1 reaches a predetermined mounting position of the imaging apparatus, along the first direction, the first power output member 101 comes into contact with the conductive assembly 26/a power input section 26b at a point D, but the second power output member 102 is not electrically connected to the conductive assembly 26. Along the first direction, a developing roller power supply section 26c has a first exposed surface 26c1 facing the right side 52. Preferably, the first exposed surface 26c1 is configured to be inclined with respect to the second direction, and along the second direction, the first exposed surface 26c1 becomes gradually farther from the housing 2 from the front side to the rear side. This design allows the developing cartridge 1 to be mounted to the imaging apparatus more easily.

As shown in FIG. 5B, when the developing cartridge 1 is viewed along the first direction, a straight line N parallel to the second direction is drawn. Along the third direction, projection points of the rotational axis L1 of the developing roller 31, a contact point D, and a free end of the actuating assembly 63 on the straight line N respectively are T1, T2, and T3. Along the second direction, a distance between the points T1 and T2 is s1, and a distance between the points T2 and T3 is s3, where s1>s3, which means that the contact point D is closer to the free end of the actuating assembly 63. Therefore, the effect of vibration of the developing roller 31 on the contact point D is reduced. That is to say, the first power output member 101 may stably output electric power to the power input section 26b.

It is to be noted that the free end of the actuating assembly 63 is a part of the actuating assembly 63 used to nudge the member to be detected 9 to accomplish detection.

When the transmission member 62 drives the actuating assembly 63 in a rotation manner, a rotational axis L6 of the transmission member 62 intersects the straight line N at a point T4. Along the second direction, a distance between the points T2 and T4 is s2, where s1>s2, which means that the contact point D is closer to the free end of the actuating assembly 63. Therefore, the effect of vibration of the developing roller 31 on the contact point D is reduced. When the transmission member 62 drives the actuating assembly 63 in a translation manner, the point T4 is a projection of a midpoint of the transmission member 62 in a dimension of the second direction on the straight line N.

During operation of the developing cartridge, compared with vibration generated by an interaction force between the developing roller 31 and the photosensitive drum, vibration that may be generated by the transmission member 62 and the actuating assembly 63 is smaller because the transmission member 62 and the actuating assembly 63 finally only need to nudge the member to be detected 9, and the closer proximity of the contact point D to the actuating assembly 63/transmission member 62 along the second direction is more conducive to ensuring that the first power output member 101 stably outputs electric power to the power input section 26b.

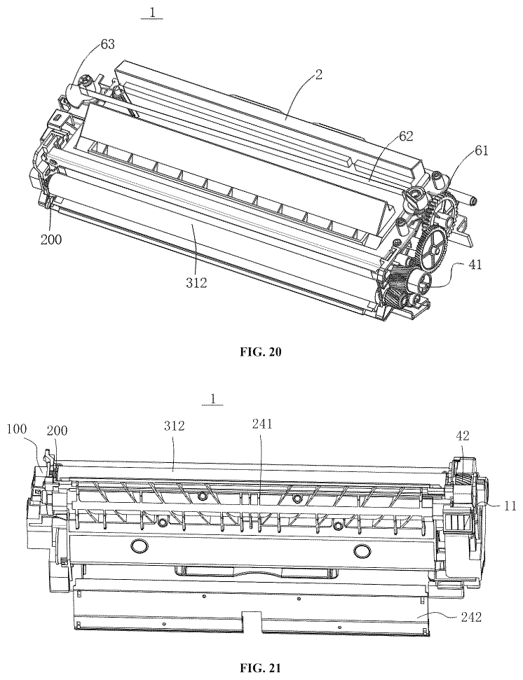

In some embodiments, as shown in FIG. 20, the transmission member 62 is configured as a flexible member such as a flexible band or a flexible rope. One end of the flexible member 62 is connected to the drive assembly 61, and the other end of the flexible member is connected to the actuating assembly 63. It may be understood that the drive assembly 61 receives a driving force from the driving force receiving member 41, and pulls the flexible member 62, so that the flexible member 62 is wound around the actuating assembly 63 and causes the actuating assembly 63 to rotate to contact the member to be detected 9, thereby enabling detection.

In some embodiments, a power source member (not shown) for providing power to the actuating assembly 63 may be provided in the developing cartridge 1, so that the actuating assembly 63 is not required to receive a driving force from the power receiving member 41 and operates independently. It may be understood that the power source member in this embodiment may include at least one of a compression spring, a tension spring, and a spiral spring.

In some embodiments, as shown in FIGS. 28 and 29, a light emitting member 300 and a first light receiving member (not shown) are provided on the imaging apparatus, and a second light receiving member (not shown) is provided on the developing cartridge. After the developing cartridge 1 is mounted on the imaging apparatus, the first light receiving member of the imaging apparatus may be continuously shield by a shielding member, and the second light receiving member selectively receives detection light emitted by the light emitting member 300, thereby enabling the detection of whether the developing cartridge is new or used.

In some embodiments, the actuation assembly 63 may receive driving force from the photosensitive drum instead of from the driving force receiving member 41.

Accordingly, this embodiment may achieve the following beneficial effects:
1. Along the second direction, compared with the distance from the contact point D between the first power output member 101 and the conductive assembly 26 to the actuating assembly 63/transmission member 62, the distance from the contact point D between the first power output member 101 and the conductive assembly 26 to the rotational axis L1 of the developing roller 31 is larger, which is favorable to reducing the impact of the vibration of the developing roller 31, making the electrical connection between the first power output member 101 and the conductive assembly 26/power input section 26b more stable.
2. As described above, the developing roller 31 conveys the developing towards the photosensitive drum, and during the process, a small amount of the developing floats away from the developing roller 31 and the photosensitive drum. Hence, the configuration of being farther from the developing roller 31 as described in point 1 may also reduce the risk of the developing floating down to the power input section 26b, thereby reducing the impact of the developing on the electrical connection between the first power output member 101 and the conductive assembly 26/the power input section 26b, and ensuring that the conductive assembly 26/power input section 26b stably receives electric power.
3. Along the first direction, the conductive assembly 26 is provided at the detection end rather than at the drive end, and thus during operation of the developing cartridge, vibration generated by the driving force transmission assembly 4 located at the drive end has less impact on the electrical connection between the first power output member 101 and the conductive assembly 26.
4. On the basis of point 3, no transmission gear is provided at the detection end, so the first power output member 101 and the conductive assembly 26 may be electrically connected more stably.
5. As shown in FIG. 5B, when viewed along the first direction, the second power output member 102 is located within a projection area of the driving force receiving member 41 at the detection end, while the first power output member 101 is located outside of the projection area. Hence, the driving force receiving member 41 during operation has less impact on the electrical connection between the first power output member 101 and the conductive assembly 26.
6. As described above, the powder feeding roller 32 is configured to supply the developing toward the developing roller 31. Generally, a voltage applied to the powder feeding roller 32 is higher than that applied to the developing roller 31. That is to say, a voltage output by the first power output member 101 is higher than that output by the second power output member 102. When the conductive assembly 26 receives electric power output by the first power output member 101, a voltage required for the powder feeding roller 32 may be ensured first, and even if there is an impedance in a main body section 26a or a conductive connection member, the voltage delivered to the developing roller 31 may meet the development requirement for the developing roller 31.

Therefore, a voltage-reducing element may also be provided between the power input section 26b and the developing power supply section 26c to ensure that the developing roller 31 receives a suitable voltage.

On the contrary, when the conductive assembly 26 receives electric power output by the second power output member 102, since the voltage originally output by the second power output member 102 is lower than the voltage required for the powder feeding roller 32, and is further subjected to the impedance of the main body section 26a or the conductive connection member, a voltage received by the powder feeding roller 32 is even lower, which is detrimental to normal operation of the powder feeding roller 32. In this embodiment, although a voltage boosting element may be provided in the conductive assembly to enable the powder feeding roller 32 to obtain a suitable voltage, obviously, a voltage reducing element has a lower cost and is easier to install.

### Embodiment 2

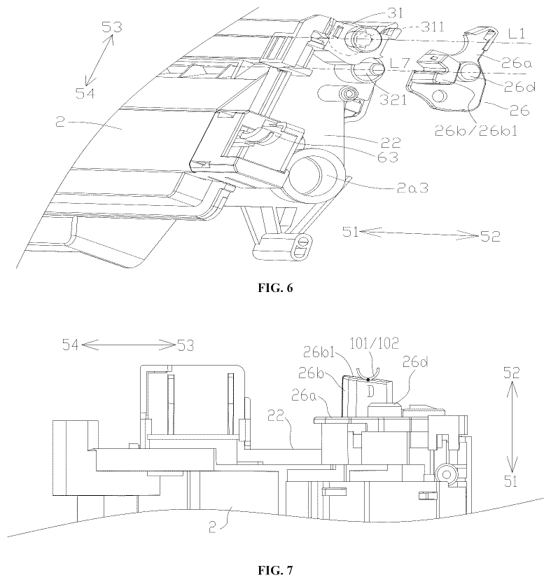

As shown in FIGS. 6 and 7, in this embodiment, the conductive assembly 26 still includes a main body section 26a, and a power input section 26b and a powder feeding roller power supply section 26d provided with the main body section 26a. The conductive assembly 26 is fixedly connected to the housing 2. The power input section 26b is configured to be electrically connected to the first power output member 101 or the second power output member 102 to receive electric power. The powder feeding roller power supply section 26d is configured to supply the electric power received by the power input section 26b to the powder feeding roller 32. Specifically, the powder feeding roller power supply section 26d is electrically connected to the powder feeding roller shaft 321 to achieve the supply of the electric power to the powder feeding roller 32. In this embodiment, the developing roller 31 is not directly supplied with electric power. For example, the developing roller 31 is not in direct electrical connection or contact with the first power output member 101 or the second power output member 102, and receives power from the powder feeding roller 32. Thus, the conductive assembly 26 is not required to be provided with a developing roller power supply section 26c configured for electrical connection to the developing roller shaft 311. Finally, the structure of the conductive assembly 26 is simplified. In some embodiments, the developing roller shaft 311 may also be made of a non-conductive material, so that even if a conductive component (e.g., the conductive assembly 26) is in contact with the developing roller shaft 311, the developing roller shaft 311 does not transmit electric power to a developing layer 312.

As shown in FIG. 6, the powder feeding roller shaft 321 is exposed from the right surface 22 of the housing. The developing roller 31 is located inside the housing 2, and in the left-right direction, the developing roller 31 does not extend beyond the right surface 22 of the housing 2. Thus, the conductive assembly 26 is not electrically connected to the developing roller 31/the developing roller shaft 311. In some embodiments, the developing roller 31 may also be configured to pass through the right surface 22, but the conductive assembly 26 is still not electrically connected to the developing roller 31/the developing roller shaft 311.

As shown in FIG. 3, the developing roller 31 further includes a developing layer 312, and the powder feeding roller 32 further includes a powder feeding layer 322, wherein the developing layer 312 is farther from a rotational axis L1 of the developing roller than a circumferential surface of the developing roller shaft 311, and the powder feeding layer 322 is farther from a rotational axis L7 of the powder feeding roller than a circumferential surface of the powder feeding roller shaft 321. The developing layer 312 and the powder feeding layer 322 are in contact with each other. Generally, the developing layer 312 and the powder feeding layer 322 are both made of an elastic material. In this embodiment, when the developing roller 31 is not directly supplied with electric power, the powder feeding layer 322 and the developing layer 312 are preferably made of an elastic conductive material. For example, the powder feeding layer 322 and the developing layer 312 are made of conductive sponge/rubber or the like. Thus, after the powder feeding roller 32 is supplied with electric power, an electric field is formed between a surface of the powder feeding roller 32 and a surface of the developing roller 31, and the developing on the surface of the powder feeding roller 32 may reach the surface of the developing roller 31 from the surface of the powder feeding roller 32 under the action of the electric field. At the same time, the electric power supplied to the powder feeding roller 32 is transmitted to the developing layer 312 through the powder feeding layer 322. Thus, the developing roller 31 is also supplied with the electric power. Subsequently, the developing regulating member 29 in contact with the surface of the developing roller 31/the developing layer 312 is also supplied with the electric power.

Further, after the powder feeding roller 32 is supplied with the electric power, the developing located on the surface of the powder feeding roller 32 becomes electrically charged, whereby an electric field is also formed between the developing on the surface of the powder feeding roller 32 and the surface of the developing roller 31. Under the action of the electric field, the developing may more easily reach the surface of the developing roller 31 from the surface of the powder feeding roller 32.

Hence, in this embodiment, not only may the powder feeding layer 322 be used as a component for supplying electric power to the developing roller 31, but the developing located between the developing roller 31 and the powder feeding roller 32 may also be used as a component for supplying electric power to the developing roller 31.

Based on the inventive concept of embodiments of the present application, the developing roller 31 and the powder feeding roller 32 may be any one of the following two specific structures:

In some embodiments, along the first direction, the developing roller shaft 311 passes through the developing layer 312, and the powder feeding roller shaft 321 passes through the powder feeding layer 322. In this case, the developing layer 312 wraps around at least a portion of the circumferential surface of the developing roller shaft 311, and the powder feeding layer 322 wraps around at least a portion of the circumferential surface of the powder feeding roller shaft 321.

In some embodiments, along the first direction, the developing roller shaft 311 does not pass through the developing layer 312, and the powder feeding roller shaft 321 does not pass through the powder feeding layer 322. In this case, the developing layer 312 wraps around a portion of the circumferential surface of the developing roller shaft 311, or the developing layer 312 does not wrap around the circumferential surface of the developing roller shaft 311, and the developing roller shaft 311 protrudes from a longitudinal end face of the developing layer 312; and the powder feeding layer 322 wraps around a portion of the circumferential surface of the powder feeding roller shaft 321, or the powder feeding layer 322 does not wrap around the circumferential surface of the powder feeding roller shaft 321, and the powder feeding roller shaft 321 protrudes from a longitudinal end face of the powder feeding layer 322.

Particularly in the case where the power input section 26b is electrically connected to the first power output member 101, the developing roller 31 may receive a higher voltage than a predetermined voltage. Even if the process cartridge 1 is in a humid, high temperature, and high-pressure environment, the amount of electric charge carried by the developing reaching the surface of the developing roller 31 may be maintained within a reasonable range, and thus degradation of the developing quality of the process cartridge 1 may be effectively suppressed.

Similar to the above embodiment, as shown in FIG. 7, the power input section 26b has a second exposed surface 26b1 facing the right side 52. The second exposed surface 26b1 is formed as a planar surface for contacting the first power output member 101/the second power output member 102 at the point D. Preferably, the second exposed surface 26b1 is configured to be inclined with respect to the second direction, and along the second direction, the second exposed surface 26b1 becomes gradually farther from the housing 2 from the front side to the rear side. Similarly, this design also allows the developing cartridge 1 to be mounted to the imaging apparatus more easily, and may prevent the first power output member 101 and the conductive assembly 26 from interfering with each other and thereby being damaged.

### Embodiment 3

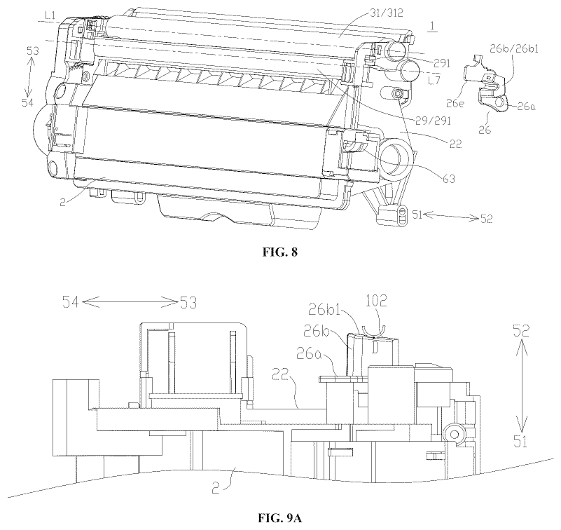

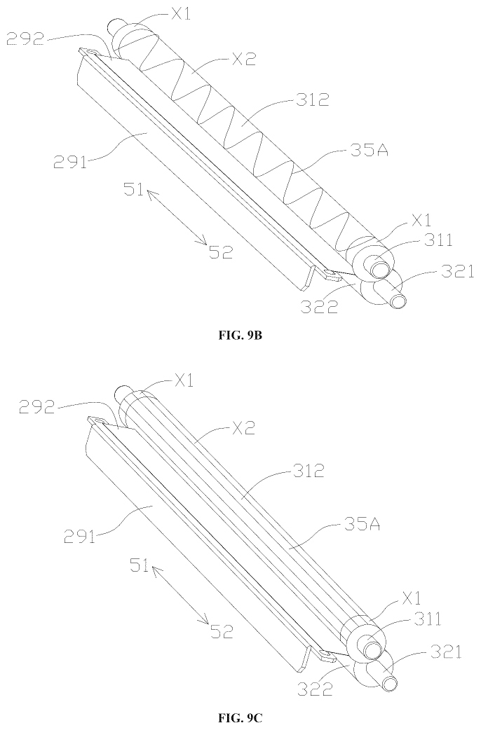

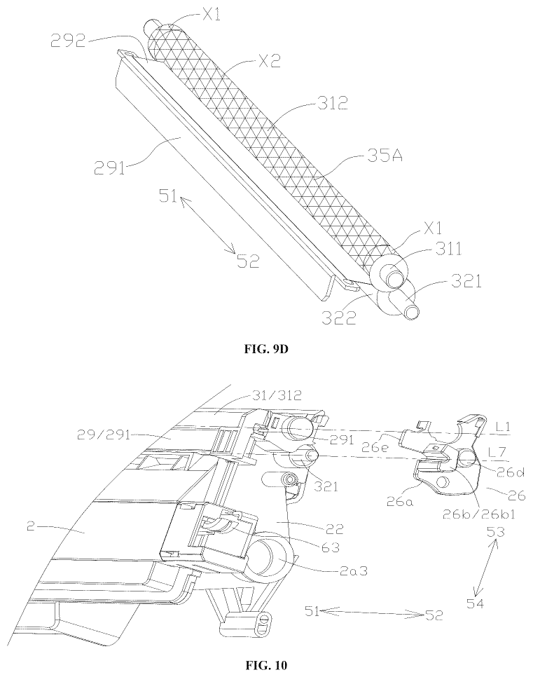

As shown in FIGS. 8, 9, and 9A to 9C, referring first to FIG. 3, the developing regulating member 29 includes a fixed body 291 fixedly connected to the housing 2, and a regulating body 292 provided on the fixed body 291. The regulating body 292 is in contact with the developing layer 312. In some embodiments, the regulating body 292 and the developing layer 312 are both made of a conductive material. Accordingly, the developing regulating member 29 enables electrical power supply to the developing roller 31. The solution will be described in detail below.

As shown in FIG. 8, the conductive assembly 26 includes a main body section 26a, and a power input section 26b and a regulating member power supply section 26e provided with the main body section 26a. The power input section 26b is configured to be electrically connected with the second power output member 102 to receive electric power. None of the developing roller 31 and the powder feeding roller 32 is directly electrically connected to the conductive assembly 26. For example, none of the developing roller 31 and the powder feeding roller 32 is in direct electrical contact with the conductive assembly 26.

Specifically, the regulating member power supply section 26e is configured to be in direct electrical contact with at least one of the fixed body 291 and the regulating body 292, such that the electric power received by the power input section 26b may be supplied to the developing regulating member 29 through the regulating member power supply section 26e. In the first direction, the regulating body 292 is in contact with the developing layer 312. Thus, the developing roller 31 receives electric power from the developing regulating member 29 through the developing layer 312 or the developing carried by the developing layer 312. Subsequently, the developing roller 31 transmits the electric power to the powder feeding roller 32 in contact with the developing roller.

As shown in FIG. 9A, the power input section 26b also has the above-described second exposed surface 26b1 inclined with respect to the second direction, which will not be repeated here. It is to be noted that the developing roller 31 in this embodiment does not receive electric power through electrical connection between the above-described developing roller shaft 311 and the conductive assembly 26, but receives electric power from the developing regulating member 29 through the developing layer 312. During operation of the developing cartridge 1, even during continuous rotation of the developing roller 31, friction generated between the developing roller shaft 311 and the conductive assembly 26 does not affect the stability of the electrical connection therebetween.

Moreover, the developing roller 31/the developing layer 311 receives electric power from the developing regulating member 29, and a position where the developing regulating member 29 is in contact with the developing roller 31/the developing layer 311 is located away from a position where the developing roller 31 and the photosensitive drum are close to each other. Thus, the developing roller 31 may receive the electric power stably even if uncontrollable vibration is generated between the developing roller and the photosensitive drum.

As described above, the conductive assembly 26 in this embodiment is not required to be provided with the aforementioned developing roller power supply section 26c and powder feeding roller power supply section 26d, and thus, the structure of the conductive assembly 26 becomes simple.

In addition, compared with the conductive mode in which the conductive assembly 26 is in contact with an end of the developing roller shaft 311, in this embodiment, the regulating body 292 is in contact with the developing layer 312/the developing roller 31 along the first direction, such that an electrical contact surface of the developing layer 312/the developing roller 31 is increased, and accordingly, the stability of the electrical connection of the developing roller 31 is improved, and a uniform voltage may be obtained on the surface of the developing roller 31/the developing layer 311.

Further, as shown in FIG. 9B, along the first direction, an outer surface of the developing roller 31/the developing layer 311 is formed with two non-developing regions X1 provided opposite to each other and a developing region X2 provided between the two non-developing regions X1, and the regulating body 292 is in contact with at least the developing region X2.

In order to obtain a more uniform voltage on the surface of the developing roller 31/the developing layer 311, the developing roller 31 further includes a power enhancement member 35 provided with the developing roller 31/the developing layer 311, the power enhancement member 35 is a conductor, and the power enhancement member 35 may extend on the outer surface of the developing roller 31/the developing layer 311, or may extend in the developing layer 311.

FIG. 9B shows a first type of power enhancement member 35A. The first type of power enhancement member 35A extends in a non-linear manner in the first direction. Specifically, the first type of power enhancement member 35A is configured to extend in a wave shape in the first direction. When the developing regulating member 29 and/or the powder feeding roller 32 described below comes into contact with the power enhancement member 35A, the power enhancement member 35A may apply a voltage uniformly to the outer surface of the developing roller 31/the developing layer 311.

When the developing roller 31 is projected in the first direction, the power enhancement member 35 is a circle formed on the developing roller 31/the developing layer 311, and the rotational axis L1 of the developing roller passes through the center of the circle.

FIG. 9C shows a second type of power enhancement member 35A. The second type of power enhancement member 35A extends in a linear manner in the first direction, and a plurality of second type of power enhancement members 35A are provided parallel to each other on the outer surface of the developing roller 31/the developing layer 311. When the developing regulating member 29 and/or the powder feeding roller 32 described below comes into contact with the power enhancement member 35A, the power enhancement members 35A may apply a voltage uniformly on the outer surface of the developing roller 31/the developing layer 311.

When the developing roller 31 is projected in the first direction, each power enhancement member 35 is a point formed on the developing roller 31/the developing layer 311.

FIG. 9D shows a third type of power enhancement member 35A. The third type of power enhancement member 35A extends in a mesh pattern in the first direction. When the developing regulating member 29 and/or the powder feeding roller 32 described below comes into contact with the power enhancement member 35A, the power enhancement member 35A may apply a voltage uniformly to the outer surface of the developing roller 31/the developing layer 311.

When the developing roller 31 is projected in the first direction, the power enhancement member 35 is a circle formed on the developing roller 31/the developing layer 311, and the rotational axis L1 of the developing roller passes through the center of the circle.

In the first type of power enhancement member 35A and the third type of power enhancement member 35C, when the developing roller 31 is projected in the first direction, the power enhancement member 35A/35C may also be an arc-shaped line formed on the developing roller 31/the developing layer 311. For example, a projection of the power enhancement member 35A/35C in the first direction is not a whole circle, and the rotational axis L1 of the developing passes through the center of the circle of the arc. However, uniform application of the voltage to the outer surface of the developing roller 31/the developing layer 311 may be achieved as long as the power enhancement member 35A/35C may come into contact with the developing regulating member 29 and/or the powder feeding roller 32 described below.

### Embodiment 4

As shown in FIGS. 10 and 11, different from Embodiment 3, the developing regulating member 29 and the powder feeding roller 32 in this embodiment are in electrical contact with the conductive assembly 26 at the same time. For example, the fixed body 291/the regulating body 292 is in direct electrical contact with the conductive assembly 26, and the powder feeding roller shaft 322 is in direct electrical contact with the conductive assembly 26. As shown in FIG. 10, the conductive assembly 26 includes a main body section 26a, and a power input section 26b, a regulating member power supply section 26e, and a powder feeding roller power supply section 26d provided with on the main body section 26a. The power input section 26b is electrically connected to the second power output member 102 to receive electric power. The regulating member power supply section 26e and the powder feeding roller power supply section 26d respectively supply the electric power to the developing regulating member 29 and the powder feeding roller 32.

Along the first direction, the developing regulating member 29 is in contact with the developing layer 312, and at the same time, the powder feeding roller 32/the powder feeding layer is also in contact with the developing layer 312. Thus, at least one of the electric power received by the developing regulating member 29 and the electric power received by the powder feeding roller 32 is supplied to the developing layer 312. In this way, the area of the developing roller 31 for receiving electric power is increased, and the electrical connection becomes more stable. Moreover, since both the developing regulating member 29 and the powder feeding roller 32 extend in the first direction, charge distribution on the developing layer 312 is more uniform.

In this embodiment, the power input section 26b also has the above-described second exposed surface 26b1 inclined with respect to the second direction, the developing roller 31 receives electric power via non-contact coupling between the developing roller shaft 311 and the conductive assembly 26. For example, the developing roller 31 is not in direct electrical contact with the conductive assembly 26. During operation of the developing cartridge 1, even during continuous rotation of the developing roller 31, frictional interference between the developing roller shaft 311 and the conductive assembly 26 is eliminated, thereby maintaining electrical connection stability.

Moreover, the developing roller 31/the developing layer 311 receives electric power from at least one of the developing regulating member 29 and the powder feeding roller 32, and a position where the developing regulating member 29 is in contact with the developing roller 31/the developing layer 311, and a position where the powder feeding roller 32 is in contact with the developing roller 31/the developing layer 311 are both away from a position where the developing roller 31 and the photosensitive drum are close to each other. Thus, the developing roller 31 may receive the electric power stably even if uncontrollable vibration is generated between the developing roller and the photosensitive drum.

### Embodiment 5

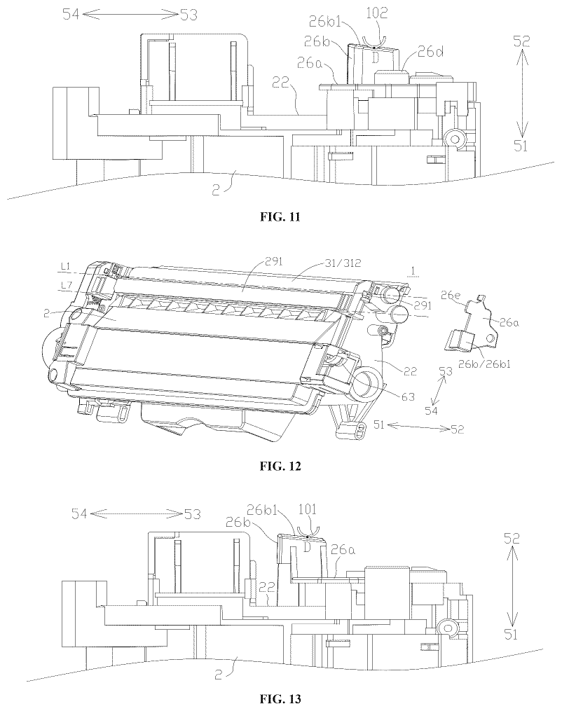

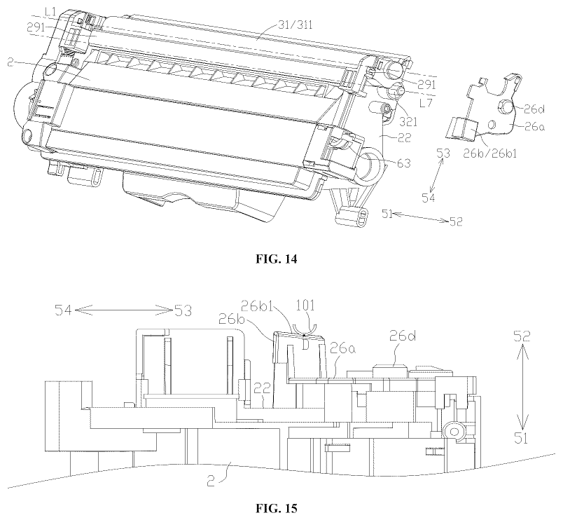

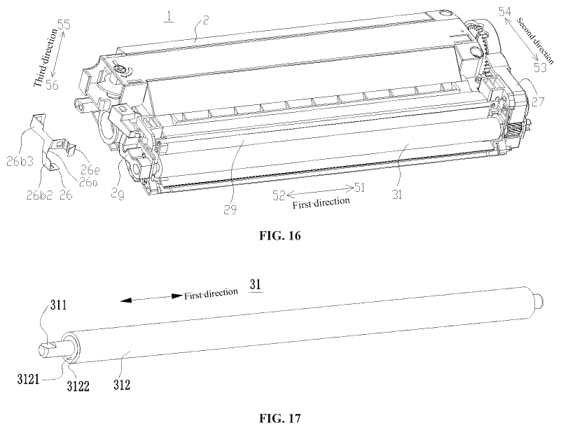

As shown in FIGS. 12 and 13, different from Embodiment 3, the conductive assembly 26 in this embodiment is electrically connected to the first power output member 101 to receive electric power, neither the developing roller 31 nor the powder feeding roller 32 in this embodiment is directly electrically connected to the conductive assembly 26. For example, neither the developing roller 31 nor the powder feeding roller 32 is in direct electrical contact with the conductive assembly 26, and the conductive assembly 26 is in direct electrical contact with the fixed body 291/the regulating body 292. Thus, the conductive assembly 26 supplies the received electric power to the developing regulating member 29. Similar to Embodiment 3, the developing regulating member 29 then supplies the electric power to the developing roller 31/the developing layer 312. Finally, the developing roller 31/the developing layer 312 supplies the electric power to the powder feeding roller 32/the powder feeding layer 322.

Similarly, the power input section 26b in this embodiment also has the above-described second exposed surface 26b1 inclined with respect to the second direction, the developing roller 31 receives electric power without requiring the developing roller shaft 311 to establish direct electrical contact between the developing roller 31 and the conductive assembly 26. During operation of the developing cartridge 1, even during continuous rotation of the developing roller 31, friction generated between the developing roller shaft 311 and the conductive assembly 26 does not affect the stability of the electrical connection therebetween.

Similar to Embodiment 3, the developing roller 31/the developing layer 311 receives electric power from the developing regulating member 29, and a position where the developing regulating member 29 is in contact with the developing roller 31/the developing layer 311 is located away from a position where the developing roller 31 and the photosensitive drum are close to each other. Thus, the developing roller 31 may receive the electric power stably even if uncontrollable vibration is generated between the developing roller and the photosensitive drum.

### Embodiment 6

As shown in FIGS. 14 and 15, different from Embodiment 4, the conductive assembly 26 in this embodiment is electrically connected to the first power output member 101 to receive electric power, and the conductive assembly 26 directly transmits the received electric power to the developing regulating member 29 and the powder feeding roller 32, and finally, the developing regulating member 29 and/or the powder feeding roller 32 supplies the electric power to the developing layer 312/the developing roller 31. For example, the fixed body 291/the regulating body 292 is in direct electrical contact with the conductive assembly 26, and the powder feeding roller shaft 321 is in direct electrical contact with the conductive assembly 26. In this way, the developing roller 31 receives electric power without requiring the developing roller shaft 311 to establish direct electrical contact between the developing roller 31 and the conductive assembly 26. For example, the developing roller 31 receives electric power via non-contact coupling between the developing roller 31 and the conductive assembly 26. During operation of the developing cartridge 1, even during continuous rotation of the developing roller 31, frictional interference between the developing roller shaft 311 and the conductive assembly 26 is eliminated, thereby maintaining electrical connection stability.

Similar to Embodiment 4, the developing roller 31/the developing layer 311 receives electric power from at least one of the developing regulating member 29 and the powder feeding roller 32, and a position where the developing regulating member 29 is in contact with the developing roller 31/the developing layer 311, and a position where the powder feeding roller 32 is in contact with the developing roller 31/the developing layer 311 are both away from a position where the developing roller 31 and the photosensitive drum are close to each other. Thus, the developing roller 31 may receive the electric power stably even if uncontrollable vibration is generated between the developing roller and the photosensitive drum.

### Embodiment 7

FIG. 16 is a schematic diagram of a state after a conductive assembly of a developing cartridge involved in Embodiment 7 of the present application is separated from a housing.

This embodiment continues to provide a structure for supplying electric power to the rotating member 3. As shown in FIG. 16, the conductive assembly 26 in this embodiment includes a developing roller power input section 26b2, a powder feeding roller power input section 26b3, and a power output section 26e, wherein the developing roller power input section 26b2 is configured to be coupled with the second power output member 102 to receive electric power output by the second power output member 102; the powder feeding roller power input section 26b3 is configured to be coupled with the first power output member 101 to receive electric power output by the first power output member 101; and the power output section 26e is configured to supply the electric power received by the developing roller power input section 26b2 and the electric power received by the powder feeding roller power input section 26b3 to at least one of the developing roller 31, the powder feeding roller 32, and the developing regulating member 29, or to the developing roller 31, the powder feeding roller 32, and the developing regulating member 29 at the same time. In the case where the electric power output by the power output section 26e is supplied to the powder feeding roller 32 or the developing regulating member 29, the powder feeding roller 32 or the developing regulating member 29 then supplies the electric power to the developing roller 31.

In a variant embodiment, the power output section 26e may also be configured to supply the electric power received by the developing roller power input section 26b2 and the electric power received by the powder feeding roller power input section 26b3 to at least one of the developing roller 31, the powder feeding roller 32, and the developing regulating member 29 at the same time.

This power supply mode has the following beneficial effects.
1. In this solution, the electric power output by the first power output member 101 and the electric power output by the second power output member 102 are received by the conductive assembly 26 at the same time, and are output by the conductive assembly 26 to at least one of the developing roller 31, the powder feeding roller 32, and the developing regulating member 29. Compared with a solution in which the first power output member 101 or the second power output member 102 is in contact with the conductive assembly 26, a current output by the conductive assembly 26 in this solution is greater, and consequently, a power received by the developing roller 31, the powder feeding roller 32, or the developing regulating member 29 is greater, which may ensure that the developing quality remains good.
2. Compared with the conductive assembly 26 outputting electric power to the developing roller 31, when the conductive assembly 26 outputs electric power to the developing regulating member 29 or the powder feeding roller 32, along the second direction, the power output section 26e is farther from the contact position of the developing roller 31 and the photosensitive drum. Thus, during operation of the developing cartridge 1, the vibration generated between the developing roller 31 and the photosensitive drum has less impact on the power output section 26e.
3. Compared with the conductive assembly 26 being in direct contact with the developing roller shaft 311, when the conductive assembly 26 outputs electric power to the developing regulating member 29 or the powder feeding roller 32, since both the developing roller 32 and the developing regulating member 29 are in direct contact with the outer surface of the developing roller 31, the electric power output by the powder feeding roller 32 or the electric power output by the developing regulating member 29 may be directly transmitted to the developing roller 31, resulting in lower electric power loss.

The developing cartridge 1 further includes a right bracket 2g for supporting the developing roller 31. The conductive assembly 26 may be formed integrally with or separately from the right bracket 2g, FIG. 16 shows a structure in which the conductive assembly 26 is formed separately from the right bracket 2g.

In summary, the power input section 26b of the conductive assembly 26 may be electrically connected to one of the first power output member 101 and the second power output member 102 to receive electric power, which is then output to at least one of the developing roller 31, the powder feeding roller 32, and the developing regulating member 29 through the power output section (at least one of the developing roller power supply section 26c, the powder feeding roller power supply section 26d, and the regulating member power supply section 26e). Preferably, the conductive assembly 26 is not provided with the developing power supply section 26c for direct electrical connection with the developing roller shaft 311. For example, the developing roller 31 is not in direct electrical contact with the conductive assembly 26, and the developing roller 31 receives electric power from at least one of the powder feeding roller 32 and the developing regulating member 29 through the developing layer 312 located on a radially outer side of the developing roller shaft 311. During operation of the developing cartridge 1, even during continuous rotation of the developing roller 31, friction generated between the developing roller shaft 311 and the conductive assembly 26 does not affect the stability of the electrical connection therebetween. Moreover, a position where the developing regulating member 29 is in contact with the developing roller 31/the developing layer 311, and a position where the powder feeding roller 32 is in contact with the developing roller 31/the developing layer 311 are both away from a position where the developing roller 31 and the photosensitive drum are close to each other. Thus, the developing roller 31 may receive the electric power stably even if uncontrollable vibration is generated between the developing roller and the photosensitive drum.

### Embodiment 8

Based on the inventive concept of the present application, this embodiment will focus on describing the structure of the developing roller 31.

As shown in FIG. 17, the developing roller 31 includes a developing roller shaft 311 and a developing layer 312 located on a radially outer side of the developing roller 31. The developing roller 31 is rotatably supported by the housing 2 through the developing roller shaft 311. The developing layer 312 is configured to carry the developing. The developing roller shaft 311 is configured as a conductive shaft. Therefore, the electrical conductivity of the developing roller 31 is further improved. Whether the conductive assembly 26 is in electrical contact with the developing roller shaft 311 or with the developing layer 312, the conductive assembly 26 may achieve stable electrical connection with the developing roller 31. The developing roller shaft 311 may be made of a conductive material (e.g., metal, and conductive resin), or a conductive material is sprayed on an outer surface of the developing roller shaft 311.

In some embodiments, the developing layer 312 includes an insulating layer 3121 and a conductive layer 3122. An outer surface of the conductive layer 3122 is formed as an outer surface of the developing roller 31/the developing layer 312. Along a radial direction of the developing roller 31, the insulating layer 3121 is located between the developing roller shaft 311 and the conductive layer 3122. That is to say, the developing roller shaft 311 and the conductive layer 3122 are separated by the insulating layer 3121. In this way, electric power supplied by the imaging apparatus may be directly supplied to the conductive layer 3122/the developing layer 312. The conductive layer 3122/the developing layer 312 directly receives electric power from the imaging apparatus. Thus, an electric field required for development may be formed between the conductive layer 3122 and the photosensitive drum. Moreover, since the insulating layer 3121 is provided, the amount of conductive material used in the conductive layer 3122 may be decreased, and consequently, the material cost of the developing roller 31 may also be reduced.

In some embodiments, the developing cartridge 1 further includes a powder feeding roller 32 (not shown) rotatably provided in the developing housing 2. The powder feeding roller 32 includes a powder feeding roller shaft 321 and a powder feeding layer 322 located on a radially outer side of the powder feeding roller shaft 321. The powder feeding roller shaft 321 is made of metal. The powder feeding layer 322 is made of a porous material. The powder feeding layer 322 is in contact with the developing roller 31/the conductive layer 3122, and is configured to convey the developing towards the developing roller 31/the conductive layer 3122.

It may be understood that in this embodiment, the imaging apparatus provides electric power to the power receiving member 41 in the developing cartridge 1, and the power receiving member 41 may be formed as part of the right bracket 2g, or may be a conductive body mounted on the right bracket 2g.

In some embodiments, the power receiving member 41 is electrically connected to the developing regulating member 29, such that the electric power supplied by the imaging apparatus may be transmitted to the conductive layer 3122 through the power receiving member 41 and the developing regulating member 29.

In other embodiments of the present application, the power receiving member may also be electrically connected to the powder feeding roller shaft 321 to achieve transmission of the electric power supplied by the imaging apparatus to the powder feeding roller 32, which then transmits the electric power to the conductive layer 3122. From this, it may be seen that the conductive assembly 26 in this embodiment may be configured to be electrically connected to at least one of the developing regulating member 29 and the powder feeding roller shaft 321.

In some embodiments, along the first direction, a length of the conductive layer 3122 and a length of the insulating layer 3121 are independently variable, as long as there is the insulating layer 3121 between the conductive layer 3122 and the developing roller shaft 311. Thus, along the first direction, the conductive layer 3122 and the insulating layer 3121 may be completely overlapped or arranged in a staggered manner. It is to be noted that the staggered arrangement referred to in this embodiment may mean that the insulating layer 3121 covers the developing roller shaft 311 and the length of the conductive layer 3122 is shorter than the insulating layer 3121.

In some embodiments, the conductive layer 3122 and the insulating layer 3121 may both be made of an elastic material. For example, the conductive layer 3122 may be made of conductive plastic or conductive rubber, and the insulating layer 3121 may be made of insulating plastic or insulating rubber. In other embodiments of the present application, the conductive layer 3122 is a conductive coating sprayed on a radially outer surface of the insulating layer 3121. In the case where the developing roller shaft 311 is made of a non-conductive material, the insulating layer 3121 may be omitted. In this case, an elastic material as the conductive layer 3122 is directly provided on a radially outer surface of the developing roller shaft 311, or a conductive coating as the conductive layer 3122 is sprayed on the radially outer surface of the developing roller shaft 311.

In some embodiments, the insulating layer 3121 may also be an insulating coating sprayed on the radially outer surface of the developing roller shaft 311 or sprayed on a radially inner side of the conductive layer 3122.

In some embodiments, the developing roller shaft 311, the insulating layer 3121, and the conductive layer 3122 are formed separately. Compared with an existing developing roller in which the radially outer side of the developing roller shaft 311 is entirely the conductive layer, the developing roller 31 involved in this embodiment not only reduces the amount of material for the conductive layer 3122, but also allows for replacement of a defective component when a defect occurs in one of the insulating layer 3121 and the conductive layer 3122, rather than replacing the entire developing layer 312, which is conducive to reducing the cost of the developing roller 31. Furthermore, when development is performed using the developing roller 31 involved in this embodiment, the electric power supplied by the imaging apparatus may be directly supplied to the conductive layer 3122, and thus, electric power loss may be reduced.

In some embodiments, the insulating layer 3121 and the conductive layer 3122 may also be formed integrally.

The developing roller 31 may be manufactured in the following sequence: first, the insulating layer 3121 is provided on the developing roller shaft 311, and then the conductive layer 3122 is provided on the insulating layer 3121. Preferably, the hardness of the developing roller shaft 311 is greater than the hardness of the insulating layer 3121, which is in turn greater than the hardness of the conductive layer 3122.

In some embodiments, the developing roller 31 may also be manufactured in the following sequence: first, the conductive layer 3122 is provided on the insulating layer 3121 to form the developing layer 312, and then the developing layer 312 is provided on the developing roller shaft 311. Preferably, the hardness of the developing roller shaft 311 is greater than the hardness of the insulating layer 3121, which is in turn greater than the hardness of the conductive layer 3122, or the hardness of the developing roller shaft 311 is greater than the hardness of the hardness of the conductive layer 3122, which is in turn greater than hardness of the insulating layer 3121.

In some embodiments, the insulating layer 3121 and the conductive layer 3122 may be joined in a sleeved dual-plastic-tube configuration to form the developing layer 312.

In addition, in this embodiment, as the electric field required for development may be formed between the conductive layer 3122 and the photosensitive drum, the conductivity of the developing roller shaft 311 becomes unimportant. For example, the developing roller shaft 311 may also be configured as a non-conductive shaft. For example, the developing roller shaft may be made of a non-conductive material, or a non-conductive material may be sprayed on the outside surface of the developing roller shaft 311. Obviously, in the case where the developing roller shaft 311 is made of a non-conductive material, it is conducive to reducing the material cost of the developing roller 31. Moreover, since the insulating material is more resistant to corrosion than metal, the problem of oxidation or corrosion of the developing cartridge 1 in a humid or high-temperature environment may be reduced, and the service life of the developing roller 31 may be prolonged.

In summary, providing the insulating layer 3121 between the developing roller shaft 311 of the developing roller 31 and the conductive layer 3122 can, on the one hand, reduce the amount of conductive material for the conductive layer 3122, thereby reducing the material cost of the developing cartridge 1, and on the other hand, enable the electric power output by the imaging apparatus to be supplied directly to the conductive layer 3122, thereby reducing electric power loss. In the case where the developing roller shaft 311 is configured as a metal shaft, the developing roller shaft has higher strength, a reduced cost and greater versatility; especially when the developing layer is replaced, it may be adapted to various developing layers.

In some embodiments, the conductive assembly 26 is not directly or indirectly electrically connected to the powder feeding roller shaft 321. Specifically, the powder feeding layer 322 may be configured as an insulating layer, so that during transfer of a toner to the developing roller 31, back-transfer of the toner on the conductive layer 3122 to the powder feeding layer 322 may be avoided, thereby ensuring print quality. It may be understood that the powder feeding roller shaft 321 in this embodiment may be configured as a metal shaft or a non-conductive shaft, which is not limited here.

### Embodiment 9

Based on the concept of the present application, the conductive mode of the developing cartridge 1 is improved in this embodiment.

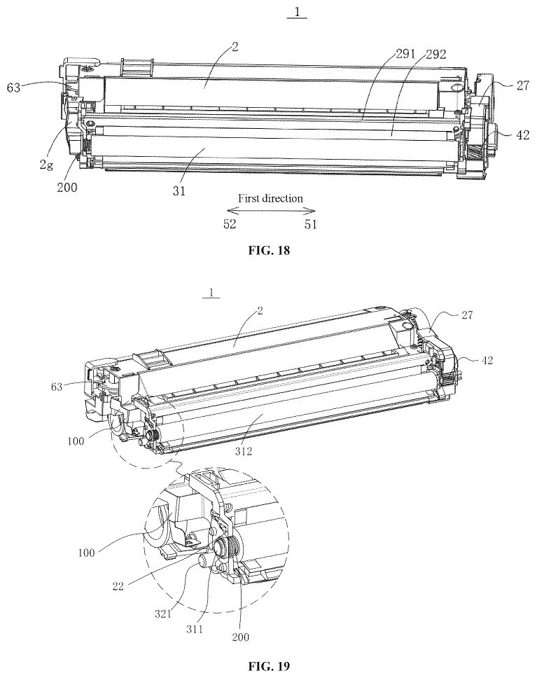

As shown in FIGS. 18 and 19, in this embodiment, the developing roller shaft 311 may be configured as an insulating shaft body. Furthermore, the electric power received by the developing layer 312 is not transmitted to the developing roller shaft 311, making the electric power received by the developing layer 312 more concentrated. For example, the outside of the developing roller shaft 311 may be sprayed with an insulating material or provided with an insulating layer 3121. Moreover, the developing cartridge 1 may include a conductive assembly electrically connected to the imaging apparatus, and the conductive assembly is configured to directly connect or indirectly connect the developing layer 312, thereby achieving the purpose of transmitting the electric power supplied by the imaging apparatus to the developing layer 312. Specifically, the conductive assembly may include a conductive member 100 (which may be regarded as the “power input section” in the above embodiments) and a conducting member 200 (which may be regarded as the “power output section” in the above embodiments) that are provided separately or integrally. For example, the electric power supplied by the imaging apparatus may be transmitted to the developing layer 312 through the conductive member 100 and the conducting member 200.

Further, the conducting member 200 in this embodiment may be a conductive spring. Specifically, as shown in FIGS. 18 and 19, the conductive spring is sleeved on an outer side of the developing roller shaft 311. Moreover, one end of the conductive spring is connected to the conductive member 100, and the other end of the conductive spring may abut against an end of the developing layer 312 in the first direction, thereby achieving the purpose of supplying the electric power to the developing layer 312. It may be understood that the end of the developing layer 312 in the first direction mentioned in this embodiment is a non-developing region X1 on the developing layer 312 on a side close to the conductive member 100 (as shown in FIG. 9B), and the end may include an end face of the developing layer 312 and a circumferential surface connected to the end face in the non-developing region X1.

In some embodiments, as shown in FIG. 19, the conductive spring may be inserted through the conductive member 100. By further increasing a contact area of the conductive spring and the conductive member 100, this ensures that the conductive spring transmits the electric power stably to the developing layer 312. By means of insertion connection, this may also prevent the conductive spring from dislodging from the conductive member 100. Alternatively, the conductive spring may be configured to be merely in contact with the conductive member 100. This is not limited here. It may be understood that the conductive member 100 in this embodiment may be a bearing assembly made of a conductive material (e.g., the right bracket 2g) or a conductive sheet made of a metal material, which is not limited here.

In some embodiments, the developing layer 312 may be a conductive elastic body, and the developing layer 312 is located on a radially outer side of the developing roller shaft 311, Preferably, the developing layer 312 has a diameter of φ10 mm to $13 mm, the developing roller shaft 311 has a diameter of φ3 mm to φ8 mm, the conductive spring has an outer diameter of φ3.5 mm to φ13 mm, and the conductive spring has a wire diameter of φ0.2 mm to φ1 mm, thereby ensuring the conductive effect while also saving manufacturing costs and optimizing the space at the conductive end. Furthermore, in other embodiments, the conductive spring is provided between an end face of the right bracket 2g and the end face of the developing layer 312; and/or in the first direction, the conductive spring is provided between the end face of the right bracket 2g and an end of the regulating body 292. Specifically, in a compressed state of the conductive spring, the length of the conductive spring is less than or equal to one-fourth of the length of the developing layer 312. In addition, to avoid the risk that excessive compression of the conductive spring causes possible deformation of the developing layer 312, a compression amount of the conductive spring may be controlled between 0.5 mm and 20 mm.

In some embodiments, the conductive spring may abut against the end face of the developing layer 312 (as shown in FIG. 19); or the conductive spring is in contact with or wrapped around the circumferential surface of the non-developing region X1 of the developing layer 312, which is not limited here. In other embodiments, referring to FIG. 18, the developing layer 312 may include an insulating layer 3121 and a conductive layer 3122. The insulating layer 3121 is provided between the developing roller shaft 311 and the conductive layer 3122. In this case, the conductive springs may just abut against the end face of the conductive layer 3122.

In some embodiments, the developing roller shaft 311 may be configured as a conductive shaft made of a metal material. In this case, the conductive spring and the developing roller shaft 311 are spaced apart in a radial direction, to avoid transmission of the electric power to the developing roller shaft 311. Moreover, it may be understood that in the case where the developing roller shaft 311 is configured as an insulating shaft body, there is no limitation on whether the conductive spring is in contact with or spaced apart from the developing roller shaft 311. Moreover, in other embodiments, the powder feeding roller shaft 321 may also be configured as a conductive shaft or a non-conductive shaft, and an additional conducting member 200 (e.g., a conductive spring) may be provided to connect the conductive member 100 and the powder feeding layer 322.

In some embodiments, when the driving force receiving member 41 drives the developing roller 31 to rotate, the conductive spring may rotate together with the developing layer 312 (preferably rotating clockwise), or the developing layer 312 rotates relative to the conductive spring. Preferably, the conductive spring and the developing layer 312 rotate together, to avoid the problem of the conductive spring rubbing against the developing layer 312 and thus damaging the developing layer 312, as well as the problem of resistance caused by the conductive spring to the rotation of the developing layer 312. Moreover, the mode of rotating together also ensures the stability of the conductive connection between the conductive spring and the developing layer 312, to further ensure the print quality of the imaging apparatus.

In some embodiments, as shown in FIGS. 18 and 19, the developing roller driving member 42 receives a driving force from the driving force receiving member 41 and rotates together with the developing roller 31, and the developing roller driving member 42 is configured as a helical gear, wherein along a direction from the left end cap 27 to the right bracket 2g, a helical direction of the conductive spring and a rotation direction of the developing roller 31 are the same, both rotating in a clockwise direction or in a counterclockwise direction. Preferably, both rotate in the counterclockwise direction. Moreover, along the direction from the left end cap 27 to the right bracket 2g, when both the helical direction of the conductive spring and the rotation direction of the developing roller 31 are counterclockwise, the helical gear is a left-handed gear; and when both the helical direction of the conductive spring and the rotation direction of the developing roller 31 are clockwise, the helical gear is a right-handed gear. It may be understood that a contact surface of the helical gear is subjected to force during rotation, such that the developing roller 31 rotating together with the gear has a tendency to move towards the detection end, making the transmission of electric power among the developing roller 31, the conductive spring 200, and the conductive member 100 more stable.

In some embodiments, in the first direction, a projection of the developing roller driving member 42 at least partially overlaps with a projection of the conductive spring.

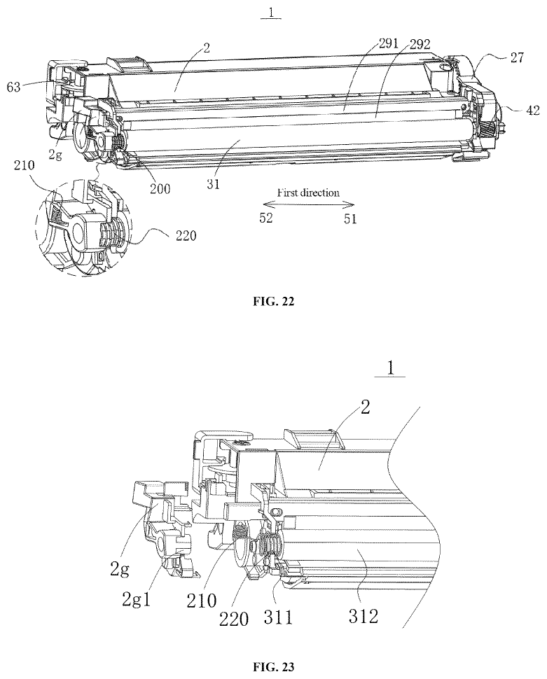

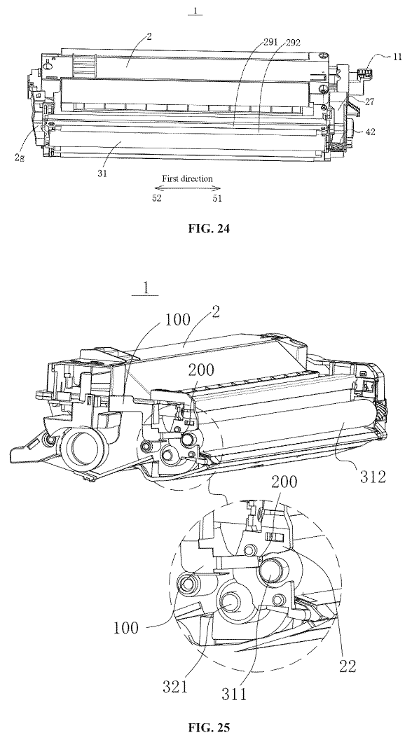

In some embodiments, as shown in FIG. 21, an axis of the conducting member 200 may be configured to be perpendicular to a normal line of the chip assembly. In addition, a plurality of reinforcing ribs 241 are provided at the bottom of the developing cartridge 1, and a protective plate 242 may be provided and cover the reinforcing ribs 241 in a removable or integrally molded manner.

In some embodiments, both the developing roller shaft 311 and the powder feeding roller shaft 321 may be configured to pass across the right surface 22, making it convenient for the conductive spring to be sleeved on the developing roller shaft 311 and the powder feeding roller shaft 321.

In some embodiments, neither the developing regulating member 29 nor the powder feeding roller shaft 321 is electrically conductive. For example, the developing regulating member 29 and the powder feeding roller shaft 321 may be made of a non-conductive material, or an insulating material may be sprayed on the surfaces of the developing regulating member 29 and the powder feeding roller shaft 321.

In some embodiments, in the first direction, the conducting member 200 does not overlap with the driving force receiving member 41, thereby further reducing the impact of the driving force receiving member 41 on the conducting member 200. In other embodiments, in the first direction, the conducting member 200 does not overlap with the detection apparatus 6. In other embodiments, in the first direction, the conducting member 200 does not overlap with the developing regulating member 29. Specifically, the conducting member 200 does not overlap with the fixed body 291/the regulating body 292/a bent portion for connecting the fixed body 291 and the regulating body 292.

### Embodiment 10

As shown in FIGS. 22 and 23, in this embodiment, the conductive member 100 is omitted, and the conducting member 200 is regarded as the conductive assembly to directly contact the power output member of the imaging apparatus, wherein one end of the conducting member 200 is in contact with the power output member of the imaging apparatus to receive electric power, and the other end of the conducting member 200 abuts against an end of the developing layer 312 in the first direction to supply the electric power to the developing layer 312.

Specifically, in this embodiment, the conducting member 200 is sleeved over the developing roller shaft 311 and spaced apart from the developing roller shaft 311 to form an inter-space, wherein the conducting member may include a first conducting part 210 and a second conducting part 220 electrically connected to each other. The first conducting part 210 is configured to be connected to the power output member of the imaging apparatus, and the second conducting part 220 is configured to abut against an end face of the developing layer 312. It is to be noted that since the conducting member 200 is sleeved over the developing roller shaft 311, and an inter-space is formed between the conducting member and the developing roller shaft 311, the developing roller shaft 311 in this embodiment is not required to be configured as an insulating shaft body. For example, the developing roller shaft 311 may be configured as a conductive shaft made of a metal material, thereby further saving manufacturing costs.

Further, in this embodiment, the right bracket 2g is provided with an exposure hole through which the first conducting part 210 is exposed, and the right bracket 2g is provided with a bushing 2g1 corresponding to the inter-space. When the right bracket 2g is mounted to the developing cartridge 1, the bushing 2g1 may be located between the end face of the right bracket 2g and the end face of the developing layer 312, and the bushing 2g1 may be sleeved over the developing roller shaft 311, thereby preventing the developing roller shaft 311 from coming into contact with the second conducting part 220 and conducting electricity during rotation. It may be understood that the bushing 2g1 may be provided independently of the right bracket 2g, or may be integrally molded with the right bracket 2g, and the bushing 2g1 is made of an insulating material.

In some embodiments, the first conducting part 210 and the second conducting part 220 are both conductive springs, and the first conducting part 210 and the second conducting part 220 are integrally molded.

In some embodiments, the first conducting part 210 is in contact with or wrapped around the circumferential surface of the non-developing region X1 of the developing layer 312.

In some embodiments, the first conducting part 210 may rotate together with the developing layer 312 (preferably rotating counterclockwise), or the developing layer 312 may rotate relative to the first conducting part 210.

In some embodiments, axes of the first conducting part 210 and the second conducting part 220 are arranged to intersect. Specifically, the axes of the first conducting part 210 and the second conducting part 220 are substantially perpendicular to each other.

### Embodiment 11

As shown in FIGS. 24 and 25, in this embodiment, the conductive member 100 is still included. The conductive member 100 is configured as a conductive sheet made of a metal material. The conducting member 200 may be a metal sheet-like, and one end of the conducting member 200 is connected to the conductive member 100, and the other end of the conducting member 200 may abut against an end of the developing layer 312 in the first direction, thereby achieving the purpose of supplying electric power to the developing layer 312.

In this embodiment, as shown in FIG. 25, the metal sheet-like conducting member 200 may abut against an end face of the developing layer 312, and the conducting member 200 is located at a position away from the photosensitive drum, thereby avoiding the risk of the conducting member 200 coming into contact with and scratching the photosensitive drum when the developing roller and the photosensitive drum rotate. Specifically, in a width direction of the developing cartridge 1, the conducting member 200 is located at the end face of the developing layer 312, and is provided closer to the developing regulating member 29/the conductive member 100/the powder feeding roller 32.

It may be understood that, in other embodiments, a plurality of conducting members 200 may be provided. The plurality of conducting members 200 surround and abut against a periphery of a side surface of the developing layer 312, and the plurality of conducting members are all provided away from the photosensitive drum; or the conducting members 200 are in the form of circular patches, and surround and abut against the circumferential surface of the non-developing region X1 of the developing layer 312, so as to further ensure the conductive effect by increasing a contact area between the conducting members 200 and the developing layer 312. In other implementations, only one conducting member 200 is provided, and is in contact with the circumferential surface of the non-developing region X1 of the developing layer.

In some embodiments, when the driving force receiving member 41 drives the developing roller 31 to rotate, the conducting member 200 may rotate together with the developing layer 312 (preferably rotating counterclockwise), or the developing layer 312 rotates relative to the conducting member 200. Preferably, the developing layer 312 rotates relative to the conducting member 200, thereby not only ensuring the stability of the connection between the conductive member 100 and the conducting member 200, but also avoiding the risk of the conducting member 200 coming into contact with and scratching the photosensitive drum, so as to further ensure the print quality of the developing cartridge 1.

In some embodiments, the conducting member 200 and the conductive member 100 may be integrally molded to increase the stability of the connection between the conducting member 200 and the conductive member 100, and improve the overall strength of the conducting member 200.

In some embodiments, the detection apparatus 6 may be omitted from the developing cartridge 1, and the chip assembly 11 may be provided on the left end cap 27.

### Embodiment 12

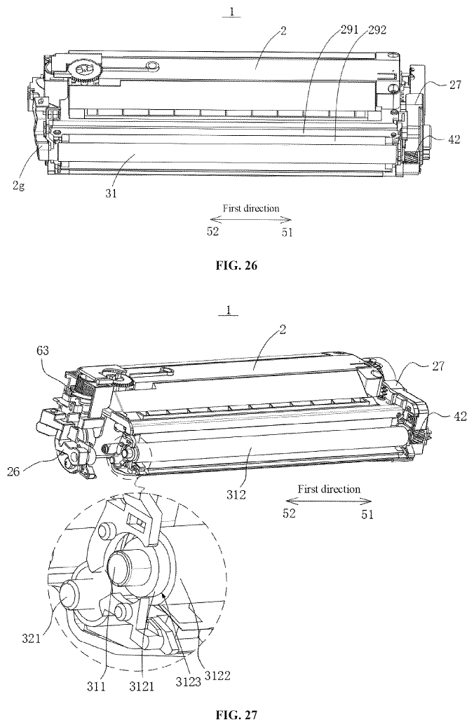

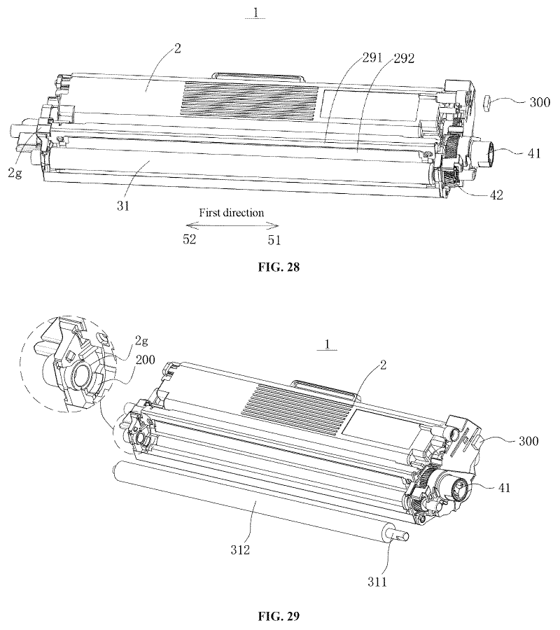

As shown in FIGS. 26 and 27, the conductive assembly 26 is still included. The conductive assembly 26 is configured as a bearing assembly (e.g., the right bracket 2g) made of a conductive material. In this embodiment, one side of the right bracket 2g may receive electric power from the imaging apparatus, and the other side of the right bracket abuts against the developing layer 312 to achieve the purpose of supplying the electric power to the developing layer 312.

Further, as shown in FIG. 27, the developing layer 312 may include a developing inner layer 3121 and a developing outer layer 3122 having different lengths in the first direction, wherein the developing inner layer 3121 is provided on a radially outer side of the developing roller shaft 311, and the developing outer layer 3122 is provided on a radially outer side of the developing inner layer 3121, and the developing inner layer 3121 and the developing outer layer 3122 are both conductive elastic bodies.

Further, in the first direction, the length of the developing outer layer 3122 is shorter than the length of the developing inner layer 3121, to form a step portion 3123. Moreover, the right bracket 2g is provided with a protruding portion (not shown in the drawings) corresponding to the step portion 3123. For example, when the right bracket 2g is mounted to the developing housing 2, the protruding portion may abut against the step portion 3123, thereby achieving the purpose of electrically connecting the right bracket 2g to the developing layer 312, making the electrical connection effect more stable by increasing a contact area between the right bracket 2g and the developing layer 312. Moreover, this may also improve the stability of the connection between the right bracket 2g and the developing layer 312, avoid shaking of the developing roller 31, and ensure a printing effect. In some embodiments, the length of the developing outer layer 3122 may be greater than the length of the developing inner layer 3121 such that the step portion 3123 is formed inside the developing layer 312.

In some embodiments, the developing inner layer 3121 may be regarded as an insulating layer, and the developing outer layer 3122 may be regarded as a conductive layer. In this case, the protruding portion abuts against an end face of the developing outer layer 3122 or a circumferential surface of the non-developing region X1 of the developing outer layer 3122.

In some embodiments, the developing inner layer 3121 and the developing outer layer 3122 may be integrally molded into the developing layer 312. For example, the step portion 3123 may be formed at an end of the developing layer 312 close to the right bracket 2g.

In some embodiments, the step portion 3121 may be a square notch formed in the developing layer 312, or an annular notch formed circumferentially around the circumferential surface of the non-developed region X1 of the developing layer 312.

In some embodiments, in the case where the developing roller shaft 311 is a metal shaft, the right bracket 2g is further provided with a shaft support space that accommodates the developing roller shaft 311, and an insulating sleeve that encases the developing roller shaft 311 may be provided in the shaft support space, to further avoid electric conduction of the developing roller shaft 311.

### Embodiment 13

As shown in FIGS. 28 and 29, the conductive assembly is still included, which comprises the conductive member 100 and the conducting member 200. The conductive member 100 is configured as a bearing assembly (e.g., the right bracket 2g) made of a conductive material. In this embodiment, one side of the right bracket 2g may receive electric power from the imaging apparatus, and the other side of the right bracket is connected to the developing layer 312 to achieve the purpose of supplying the electric power to the developing layer 312.

As shown in FIG. 29, the conducting member 200 is metal sheet-like, and one side of the conducting member 200 is connected to the right bracket 2g, and the other side of the conducting member is connected to the developing layer 312. Specifically, the conducting member 200 may be independently provided between the right bracket 2g and the developing layer 312. Further, the conducting member 200 is in the form of an arc-shaped sheet and in contact with the circumferential surface of the non-developing region X1 of the developing layer 312, so as to achieve the purpose of protecting the developing layer while ensuring the transmission of electric power to the developing layer 312.

In some embodiments, the conducting member 200 is located on an end face of the right bracket 2g on a side close the developing layer 312, and the conducting member 200 may be placed on the right bracket 2g or fixed to the right bracket 2g by means of removable connection.

In some embodiments, the conducting member 200 is located at a position away from the photosensitive drum, thereby avoiding the risk of the conducting member 200 coming into contact with and scratching the photosensitive drum when the developing roller and the photosensitive drum rotate. Specifically, in a width direction of the developing cartridge, the conducting member 200 is located on the circumferential surface of the non-developed region X1 of the developing layer 312, and is provided closer to the developing regulating member 29/the conductive member 100/the powder feeding roller 32.

### Embodiment 14

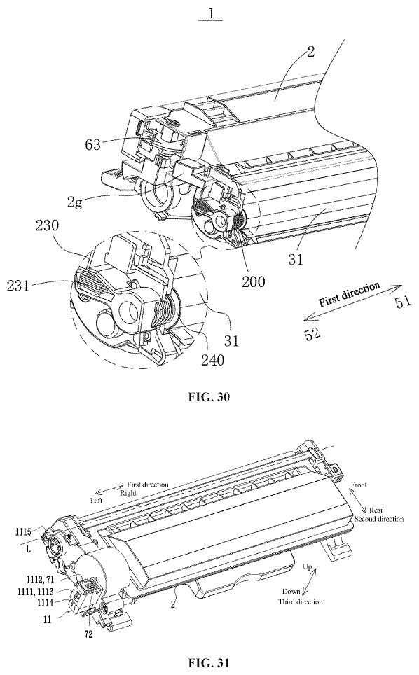

This embodiment is a further improvement on the basis of Embodiment 10. As shown in FIG. 30, the conducting member 200 includes a first conductive part 230 and a second conductive part 240 that are electrically connected to each other. The first conductive part 230 is configured to be connected to the power output member of the imaging apparatus. The second conductive part 240 is electrically connected to an end of the developing layer 312. The first conductive part 230 and the second conductive part 240 are provided separately. The first conductive part 230 in this embodiment includes the first conducting part 210 and the second conducting part 220 in Embodiment 10.

The first conductive part 230 abuts against the second conductive part 240. The second conductive part 240 is located on a radially outer side of the developing roller shaft 311, and fits against an end face of the developing layer 312. The area of a region of the second conductive part 240 in contact with the end face of the developing layer 312 is S1, and one-half of the area of the end face of the developing layer 312 is S2, where S1>S2. Specifically, the second conductive part 240 is configured as an annular metal sheet, and the annular metal sheet fits against the end face of the developing layer 312. Such a structure is conducive to increasing the area of electrical contact between the conducting member 200 and the developing layer 312/the conductive layer 3122, and to improving the stability and conduction efficiency of the electrical connection between the conducting member 200 and the developing layer 312/the conductive layer 3122.

The first conductive part 230 has an electrical contact surface 231 connected to the power output member of the imaging apparatus, and the electrical contact surface 231 extends in the second direction of the developing cartridge 1. The electrical contact surface 231 may be inclined with respect to the second direction or the third direction.

In the first direction, the first conducting part 210 is a square coil, and the second conducting part 220 is a circular spring. The square coil is fixed relative to the developing housing. The electrical contact surface 231 is a surface of the square coil facing the exterior of the developing cartridge 1. Such a structure is conducive to increasing the area of electrical contact between the conducting member 200 and the imaging apparatus, and to improving the stability and conduction efficiency of the electrical connection between the conducting member 200 and the imaging apparatus.

In some embodiments, the second conductive part 240 is configured to be at least partially embedded in the interior of the developing layer 312 and electrically connected to the conductive layer 3122. Specifically, the second conductive part 240 has a tip portion, which may be inserted into the interior of the developing layer 312. Such a structure is conducive to increasing the area of electrical contact between the conducting member 200 and the developing layer 312/the conductive layer 3122, and to improving the stability and conduction efficiency of the electrical connection between the conducting member 200 and the developing layer 312/the conductive layer 3122.

In some embodiments, a conductive paste is applied at the connection between the second conductive part 240 and the developing layer 312 to increase the area of the electrical connection between the conducting member 200 and the developing layer 312/the conductive layer 3122, and to improve the stability and conduction efficiency of the electrical connection between the conducting member 200 and the developing layer 312/the conductive layer 3122.

In some embodiments, the resistance of the developing layer 312 is less than 0.5MΩ. Further, the resistance of the developing layer 312 is less than 0.2MΩ. This facilitates the electrical connection between the conducting member 200 and the developing layer 312.

In some embodiments, the first conductive part 230 and the second conductive part 240 may also be integrally molded or fixedly connected.

In this embodiment, the conducting member 200 may be regarded as a conductive assembly; and the conductive assembly may be a single component, or may be composed of a plurality of components.

In summary, in the above embodiment, the electric power supplied by the imaging apparatus may be transmitted to the developing layer through the conductive assembly, thereby achieving the following effects.
1. An intermediate link of charge conduction through the roller shaft is reduced, such that contact resistance and energy loss are lowered, and charge transfer efficiency is improved.
2. By supplying power directly to the surface of the developing layer, more precise electric field control may be achieved, avoiding uneven charge distribution caused by roller material properties or mechanical tolerances.
3. Mechanical friction contact between the conductive member and the rotating roller shaft is avoided such that metal fatigue and oxidation probability are reduced. A wear-resistant conductive layer may be formed on the surface of the developing layer by a coating process, which ensures charge transfer while reducing physical wear and extending the service life of the developing cartridge.
4. In a variable voltage development (VCS) system, direct control of an electrical potential of the developing layer enables a faster response to transient changes in a development bias voltage. For example, under pulsed charging, a surface power-supply mode may shorten voltage buildup time by 30% to 50%, meeting the high-speed development requirement for high-resolution images.
5. For a non-metallic developing roller (e.g., ceramic-coated or made of a composite material), conventional shaft-end power supply may be limited. Direct surface power supply may overcome material conductivity limitations, support the design of the developing layer with higher resistivity, and broaden material selection to optimize toner charging characteristics.

### Embodiment 15

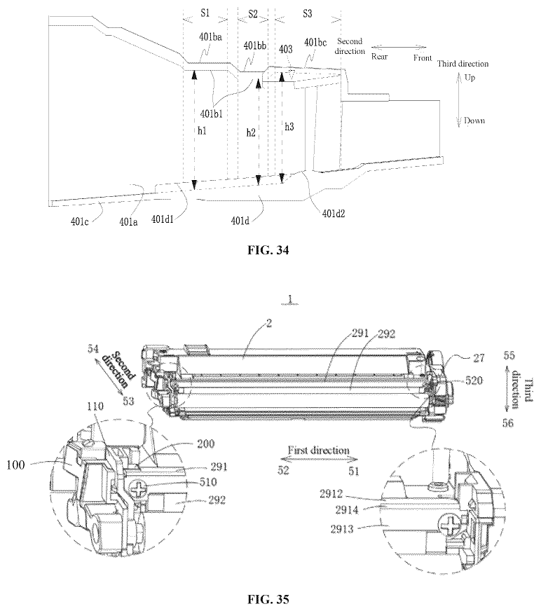

As shown in FIG. 35, in this embodiment, the conductive assembly is connected to the developing regulating member 29, and in the first direction, a projection of the conductive assembly does not overlap with a projection of the developing regulating member 29. Further, the developing cartridge includes a conductive member 100. The conductive member 100 is configured as a conductive sheet made of a metal material. In the first direction, a projection of the conductive member 100 does not overlap with the projection of the developing regulating member 29. For example, when viewed along the first direction, the projection of the conductive member 100 and the projection of the developing regulating member 29 do not overlap. The fixed body 291 is fixed to a developing frame 110 by a first threaded fastener 510 and the second threaded fastener 520. The conducting member 200 is also configured as a metal conductive member. One end of the conducting member 200 is connected to the conductive member 100, and the other end of the conducting member is configured to connect the fixed body 291, and in the first direction, a projection of the conducting member 200 does not overlap with the projection of the developing regulating member 29, thereby achieving the purpose of supplying electric power to the developing regulating member 29 and the developing layer 312.

Specifically, in the third direction, the conducting member 200 is configured to connect one end of the fixed body 291, and is located on a side of the fixed body 291 away from the regulating body 292, so that in the third direction, by disposing the conducting member 200 above the fixed body 291, the projection of the conducting member 200 in the first direction does not overlap with the projection of the developing regulating member 29. Compared with a solution in which the conducting member 200 abuts against the end of the fixed body 291 in the prior art, not only may the assembly of the developing cartridge 1 be simplified by staged installation of the conducting member 200 and the fixed body 291, avoiding assembly interference between the conducting member 200 and the fixed body 291, so as to prolong the service life of the conducting member 200 and the fixed body 291, but also the contact area between the conducting member 200 and the fixed body 291 may be further increased to ensure the stability of electric power transmission. The conducting member 200 is provided above the fixed body 291 in the third direction by means of removable connection such as gluing, snap-fitting, threaded connection, or magnetic attachment connection, or by means of fixed connection such as welding.

In some embodiments, as shown in FIG. 35, the fixed body 291 includes a first flat portion 2912, a second flat portion 2913, and a bent portion 2914 for connecting the first flat portion 2912 and the second flat portion 2913. The first flat portion 2912 and the second flat portion 2913 are substantially at a right angle. The regulating body 292 is fixed to the second flat portion 2913 by a first threaded fastener 510 and a second threaded fastener 520. In the above embodiment, the conducting member 200 is in contact with the first flat portion 2912 on an outer side of the third direction, it may reduce the impact of vibration on the conductive member 200 caused by the contact between the regulating body 292 and the rotatable developing roller 31, thereby enabling the conductive member 200 to maintain stable electrical connection with the first flat portion 2912. In other embodiments, the conducting member 200 is in contact with the inner side of the first flat portion 2912 along the third direction.

In the above embodiment, the conducting member 200 may be in contact with the second flat portion 2913 on an inner side of the second direction; it may reduce the impact of vibration on the conductive member 200 caused by the contact between the regulating body 292 and the rotatable developing roller 31, thereby enabling the conductive member 200 to maintain stable electrical connection with the second flat portion 2913, or the conducting member 200 passes through the developing frame 110 and is in contact with the second flat portion 2913 on an outer side of the second direction.

In some embodiments, the conductive member 100 and the conducting member 200 may be integrally molded or separately provided.

In some embodiments, both the conductive member 100 and the conducting member 200 may be configured as a metal conductive member with a bending portion, thereby by means of providing the bending portion, the projection of the conductive member 100 and the projection of the conducting member 200 do not overlap with the fixed body 291 in the first direction.

In some embodiments, an end of the conducting member 200 for connecting the fixed body 291 may be provided with a bending part thereby further improving the overall strength of the conducting member.

In some embodiments, the conducting member 200 may be inserted through the developing frame 110, and after the developing cartridge 1 is assembled, the conductive member 200 may be conformed to and abut against the developing frame 110 to secure the conducting member 200, thereby further improving the stability of electric power transmission between the conducting member 200 and the fixed body 291.

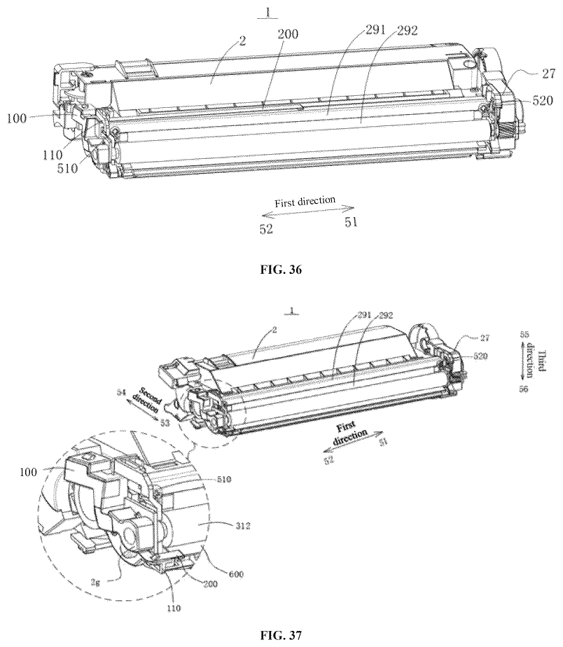

In some embodiments, as shown in FIG. 36, the conducting member 200 may be configured to extend in the first direction, thereby further increasing the contact area between the conducting member 200 and the fixed body 291. Specifically, this embodiment does not limit an extension length of the conducting member 200. For example, the extension length of the conducting member 200 in the first direction is greater than ¼, ½, or ¾ of the length of the developing regulating member 29. Preferably, a position where the conducting member 200 and the fixed body 291 are in contact is located in the middle of the fixed body 291 in the first direction.

In some embodiments, in the third direction, the end of the conducting member 200 for connecting the fixed body 291 may also be located on a side of the fixed body 291 close to the regulating body 292; or in the second direction, the end of the conducting member 200 for connecting the fixed body 291 is located on the side remote from the regulating body 292, it is possible to reduce the impact of vibrations on the conducting member 200 caused by the contact between the regulating body 292 and the rotatable developing roller 31, thereby enabling the conducting member 200 to maintain a stable electrical connection with the fixed body 291.

In some embodiments, the conductive assembly may include the conductive member 100 and the conducting member 200, or may include the conducting member 200 only.

### Embodiment 16

As shown in FIG. 37, the conductive assembly is connected to a sealing member 600 of the developing cartridge 1. The sealing member 600 is configured to seal a gap between the developing roller 31 and the housing 2 and be in contact with the developing roller 31, to avoid leakage of the toner to the outside. In the first direction, a projection of the conductive assembly does not overlap with a projection of the sealing member 600. Further, the conductive assembly of this embodiment still includes the conductive member 100 and the conducting member 200. This embodiment differs from Embodiment 15 in that the other end of the conducting member 200 and the fixed body 291 are not in contact, but the conducting member 200 is connected to the sealing member 600, thereby achieving the purpose of supplying electric power to the sealing member 600 and the developing layer 312.

Specifically, in this embodiment, the sealing member 600 is configured as a metal conductive member, and the conducting member 200 is connected to the sealing member 600 by means of removable connection such as gluing, snap-fitting, threaded connection, or magnetic attachment connection, thereby achieving the purpose of electric power transmission. It may be understood that in this embodiment, the conducting member 200 may also be integrally molded with the sealing member 600, thereby further improving the overall strength of the conducting member 200. It may be understood that in this embodiment, the conductive assembly may be in contact with an end face of the sealing member 600, or may be provided on an upper surface of the sealing member 600 in the third direction.

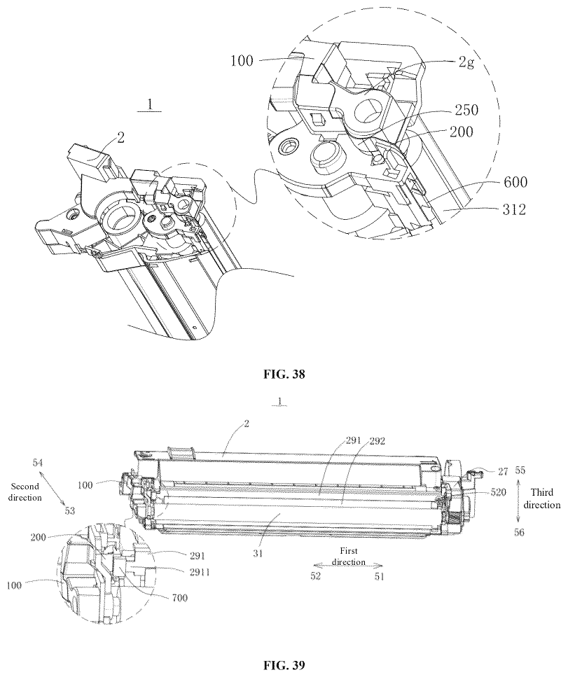

In this embodiment, referring to FIG. 38, in the first direction, the projection of the conductive member 100 and the projection of the conducting member 200 still do not overlap with the fixed body 291. Specifically, the conducting member 200 is provided with a bending portion 250, and the bending portion 250 is connected to the conductive member 100 and configured in the third direction to conform to an outer contour of the right bracket 2g, making the appearance of the developing cartridge 1 simpler, and further optimizing the overall volume of the developing cartridge 1. It may be understood that in this embodiment, the bending portion 250 may be configured in the third direction to conform to an upper side or a lower side of the right bracket 2g or be wrapped around an outer surface of the right bracket 2g. Moreover, the bending portion 250 may be conformed to the right bracket 2g by removable connection such as gluing, snap-fitting, threaded connection, or magnetic attachment connection.

In some embodiments, the conducting member 200 may be inserted through the developing frame 110 so as to be fixed by the developing frame 110; or the conducting member 200 is fixed to the developing frame 110 by means of snap-fit connection.

### Embodiment 17

In this embodiment, at least one end of the developing regulating member 29 is fixed by non-screw means, such as snap-fitting, slot insertion, or other fixing means. Compared with conventional threaded-connection mounting means, this embodiment may use a positioning-based mounting method of the developing regulating member 29 to facilitate the assembly of the developing regulating member 29 to the developing cartridge 1. It may be understood that the developing regulating member 29 in this embodiment may be fixed at one end by threaded connection, and at the other end by non-screw means, or at both ends by non-screw means.

Specifically, in this embodiment, the conductive assembly is connected to the developing regulating member 29, and in the first direction, a projection of the conductive assembly does not overlap with a projection of the developing regulating member 29. Further, this embodiment differs from Embodiment 15 is that the first threaded fastener 510 is omitted, and the developing cartridge 1 is provided with a fixing member 700. The fixed body 291 may be inserted through the fixing member 700 and connected to the conducting member 200, thereby achieving the purpose of supplying electric power to the developing regulating member 29 and the developing layer 312. In this embodiment, by omitting the first threaded fastener 510 and shortening the fixed body 291, the assembly process of the developing cartridge 1 may be simplified, and manufacturing costs may be saved. It may be understood that in the first direction, the projection of the conductive member 100 and the projection of the conducting member 200 still do not overlap with the fixed body 291.

Further, in other embodiments, as shown in FIG. 39, a length of the fixed body 291 in the first direction is set shorter than the developing roller 31. Preferably, a length of an end of the fixed body 291 close to the conductive member 100 is set shorter than the developing roller 31. Moreover, in the first direction, the fixed body 291 is further provided with a protruding portion 2911 in a direction toward the conductive member 100. A width of the protruding portion 2911 in the third direction is smaller than a width of a body of the fixed body 291.

In some embodiments, the fixing member 700 may be omitted, and a pressure plate is additionally provided in such a manner that the pressure plate abuts against the fixed body 291 in the third direction (specifically, the pressure plate may abut against an upper side of the first flat portion 2912 in the third direction), to achieve the purpose of fixing the developing regulating member 29 to the developing cartridge 1. Further, the pressure plate may be fixed to the developing cartridge 1 by snap-fitting, threaded connection or welding to the housing 2.

### Embodiment 18

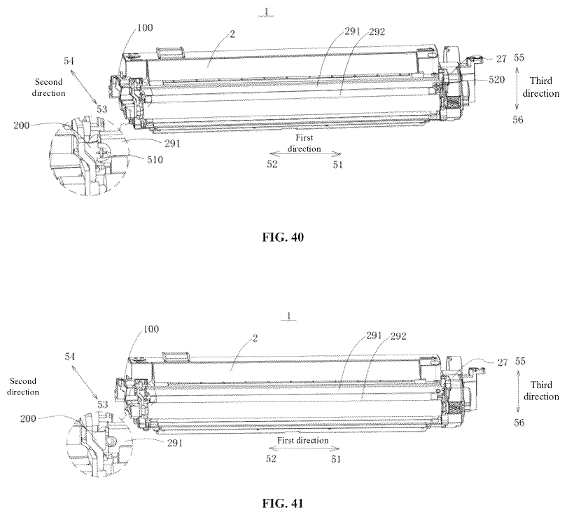

In this embodiment, as shown in FIGS. 40 and 41, in the first direction, a distance between at least a portion of the threaded fastener 510 and the electrical contact portion of the conductive assembly is k1, and a distance between an end of the developing regulating member 29 and the electrical contact portion of the conductive assembly is k2, where k1<k2. It may be understood that the electrical contact portion of the conductive assembly is a contacting point/surface of the conductive assembly configured to electrically contact the imaging apparatus.

Further, in the first direction, a distance between a screw hole (including a notch) and the electrical contact portion of the conductive assembly is k3, where k3<k1.

Specifically, the conductive assembly is electrically connected to the developing regulating member 29, and in the first direction, a projection of the conductive assembly does not overlap with a projection of the developing regulating member 29. In this embodiment, the fixing member 700 is omitted, and since the first threaded fastener 510 is configured as a metal conductive member, and the first threaded fastener 510 is connected to the conducting member 200 on one side, and connected to the fixed body 291 on the other side, the purpose of electrically connecting the conducting member 200 to the fixed body 291 may be achieved through the first threaded fastener 510. It is to be noted that in the first direction, the projection of the conductive member 100 and the projection of the conducting member 200 still do not overlap with the fixed body 291.

Further, as shown in FIGS. 40 and 41, a length of the fixed body 291 in the first direction is set shorter than the developing roller 31. Preferably, a length of an end of the fixed body 291 close to the conductive member 100 is set shorter than the developing roller 31.

In some embodiments, a pressure plate may be additionally provided in such a manner that the pressure plate abuts against the fixed body 291 in the third direction (specifically, the pressure plate may abut against an upper side of the first flat portion 2912 in the third direction), to achieve the purpose of fixing the developing regulating member 29 to the developing cartridge 1. Further, the pressure plate may be fixed to the developing cartridge 1 by snap-fitting, threaded connection or welding to the housing 2.

### Embodiment 19

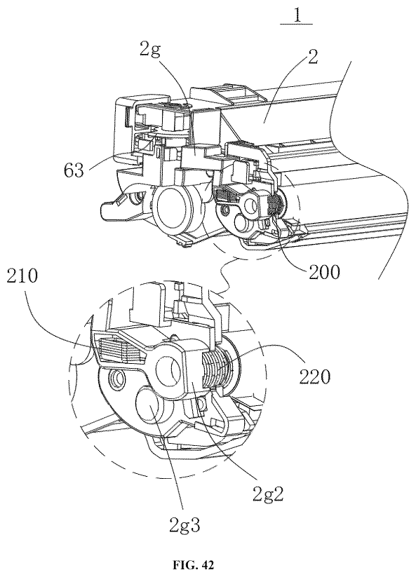

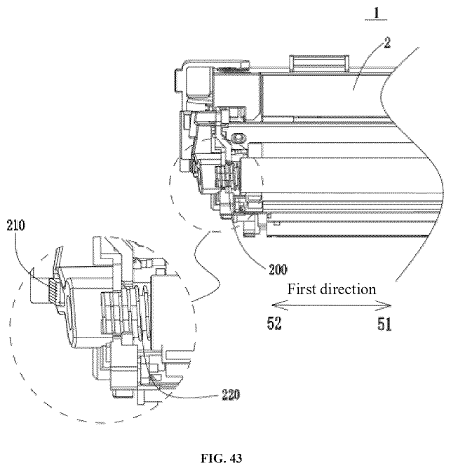

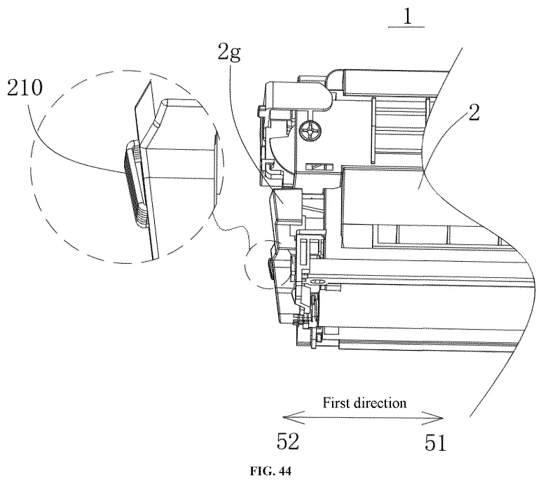

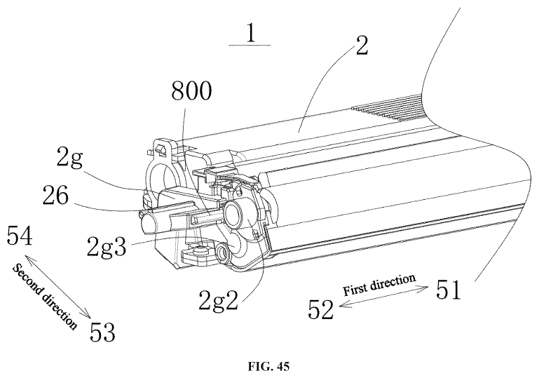

This embodiment is a further optimized solution based on Embodiment 14. As shown in FIGS. 42 to 44, in this embodiment, the right bracket 2g is configured as an insulating bracket. For example, the right bracket 2g may be made of an insulating material, or an insulating material may be sprayed on an outer surface of the right bracket 2g. The right bracket 2g is provided with a first bearing 2g2 corresponding to the developing roller shaft 311, and a second bearing 2g3 corresponding to the powder feeding roller shaft 321. Moreover, at least a portion of the conductive assembly is provided at the right bracket 2g. As shown in FIG. 43, along the first direction, at least a portion of the conductive assembly is configured to extend beyond a farthest end of the right bracket 2g. For example, along the first direction, at least a portion of the conductive assembly is configured to protrude from the farthest end of the right bracket 2g.

In some embodiments, at least a portion of the conductive assembly may also be configured to be flush with the farthest end of the right bracket 2g. For example, along the first direction, at least a portion of the conductive assembly is flush with the farthest end of the right bracket 2g.

It may be understood that by physically configuring the conductive assembly to protrude, a tight electrical connection between the conductive assembly and the imaging apparatus may be ensured, thereby avoiding problems such as abnormal toner transmission caused by uneven charging due to poor contact, and thus improving the stability of the print quality of the imaging apparatus. Moreover, the protruding conductive assembly may also form a physical positioning marker to guide a user to install the developing cartridge 1 in a correct direction, thereby reducing the risk of reverse or misaligned installation. In addition, the protruding conductive assembly may also enhance a heat dissipation effect of the conductive assembly by increasing an exposed area of the conductive assembly.

In some embodiments, at least a portion of the conductive assembly is configured to extend beyond the insulating first bearing 2g2 and second bearing 2g3 in the first direction. Further, the first conducting part 210 is configured to extend beyond the insulating first bearing 2g2 and second bearing 2g3 in the first direction.

In some embodiments, at least a portion of the conductive assembly is configured to be flush with the insulating first bearing 2g2 and second bearing 2g3 in the first direction. Further, the first conducting part 210 is configured to be flush with the insulating first bearing 2g2 and second bearing 2g3 in the first direction.

In some embodiments, as shown in FIG. 43, in the first direction, a protruding part of the first conducting part 210 protruding from the right bracket 2g may be U-shaped, thereby further increasing the exposed area of the conductive assembly. Moreover, by increasing the exposed area, the overall strength of the conductive assembly may also be further enhanced, while improving electrical connectivity. It may be understood that in this embodiment, the protruding part may also be circular, arc-shaped, or in other shapes, which is not limited here.

### Embodiment 20

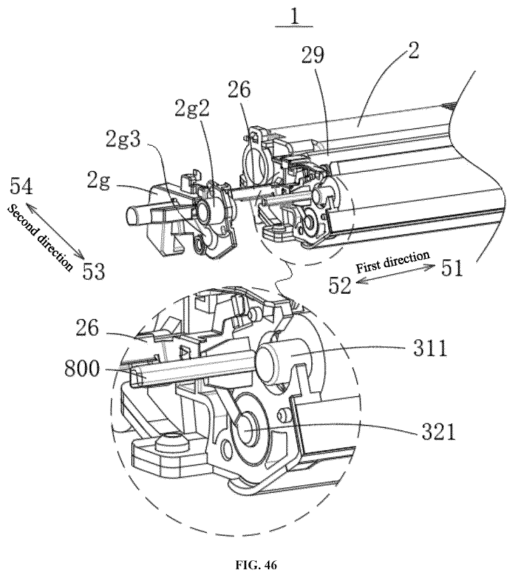

In some embodiments, as shown in FIGS. 45 and 46, the conductive assembly 26 is configured to extend in the second direction. Further, in this embodiment, a projection of the extending conductive assembly 26 in the first direction at least partially overlaps with a projection of a roller shaft in the first direction. It may be understood that in this embodiment, the roller shaft may be a developing roller shaft 311 or a powder feeding roller shaft 321. For example, in this embodiment, the projection of the extending conductive assembly 26 in the first direction may at least partially overlap with a projection of one of the developing roller shaft 311 or the powder feeding roller shaft 321 in the first direction, or may at least partially overlap with both projections of the two in the first direction.

It is to be noted that, in this embodiment, the extension of the conductive assembly 26 may further enhance the conductive performance and overall strength of the conductive assembly 26 by increasing the overall area of the conductive assembly 26, to further ensure the stability of electric power transmission of the imaging apparatus. Moreover, since the extending conductive assembly 26 is closer to the developing roller shaft 311/the powder feeding roller shaft 321, a voltage required for the same field strength is decreased to reduce energy consumption. In addition, the projections of the conductive assembly 26 and the developing roller shaft 311/the powder feeding roller shaft 321 may be aligned as an assembly reference to simplify an assembly process during installation, and reduce a human error.

In some embodiments, as shown in FIG. 46, at least a portion of the conductive assembly 26 is provided on an inner side of the right bracket 2g, and the conductive assembly 26 provided on the inner side of the right bracket 2g is capable of contacting the developing roller shaft 311/the powder feeding roller shaft 321 in the first direction. It may be understood that disposing the conductive assembly 26 on the inner side of the right bracket 2g so as to contact the developing roller shaft 311/the powder feeding roller shaft 321 may achieve a protective effect on the conductive assembly 26 to further ensure the conductive performance of the developing cartridge 1, while achieving the above-mentioned technical effect.

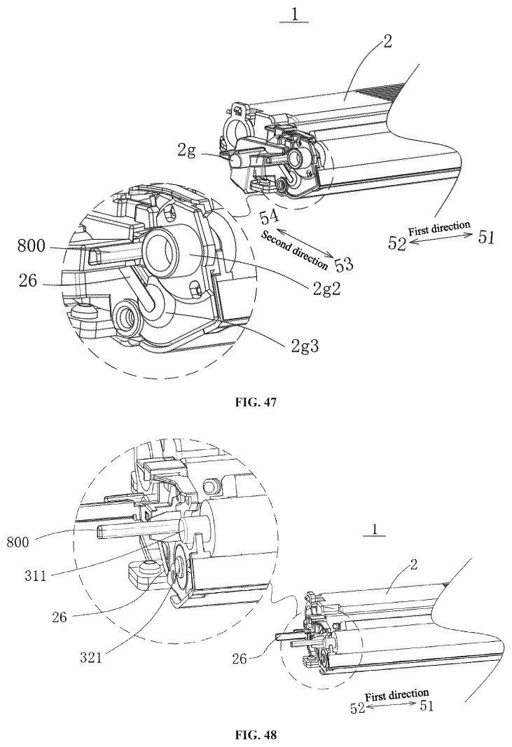

In another variant of this embodiment, as shown in FIGS. 47 and 48, at least a portion of the conductive assembly 26 is provided on an outer side of the right bracket 2g, and a projection of the conductive assembly 26 provided on the outer side of the right bracket 2g in the first direction at least partially overlaps with a projection of the developing roller shaft 311/the powder feeding roller shaft 321 in the first direction. In this embodiment, the conductive assembly 26 does not contact the developing roller shaft 311/the powder feeding roller shaft 321, and in the first direction, there is a gap between an overlapping portion of the projections of the conductive assembly 26 and the developing roller shaft 311/the powder feeding roller shaft 321, and the developing roller shaft 311/the powder feeding roller shaft 321. It may be understood that in this embodiment, disposing at least a portion of the conductive assembly 26 on the outer side of the right bracket 2g may further enhance the heat dissipation performance of the conductive assembly 26 by increasing the exposed area of the conductive assembly 26, thereby ensuring the conductive stability of the developing cartridge 1. It is to be noted that in the first direction, a distance between the conductive assembly 26 and the developing roller shaft 311/the powder feeding roller shaft 321 is preferably 0.1 mm to 5 mm.

In some embodiments, the right bracket 2g/the first bearing 2g2/the second bearing 2g3, and the conductive assembly 26 may be integrally molded. Preferably, the right bracket 2g is made of conductive resin. In this case, if it is required to electrically disconnect the developing roller shaft 311 or the powder feeding roller shaft 321 from the right bracket 2g, the developing roller shaft 311/the powder feeding roller shaft 321 may be configured as an insulating shaft body, or the developing roller shaft 311/the powder feeding roller shaft 321 is still a metal conductive shaft, but an insulating sheath is sleeved over a shaft end of the developing roller shaft 311/the powder feeding roller shaft 321, thereby establishing electrical discontinuity between the developing roller shaft 311/the powder feeding roller shaft 321 and the conductive assembly 26.

### Embodiment 21

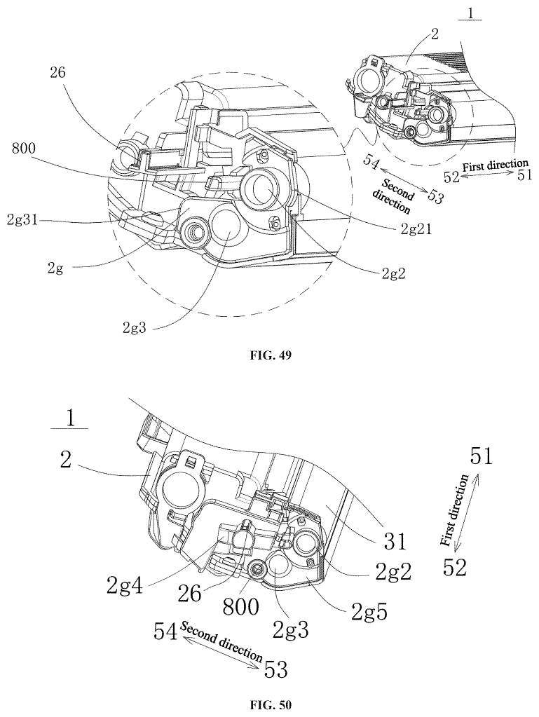

In some embodiments, as shown in FIG. 49, the developing cartridge 1 is provided with an engagement protrusion 800. The engagement protrusion 800 is configured to receive a separation force applied by the imaging apparatus so as to displace the developing cartridge 1 with respect to the drum cartridge and to enable the developing cartridge 1 to separate from the drum cartridge. It is to be noted that the engagement protrusion 800 may be provided with on the housing 2 of the developing cartridge 1, and located at on an end of the housing 2 close to the right bracket 2g. It may be understood that in other embodiments, the engagement protrusion 800 may be connected to the drum cartridge. For example, the separation force applied by the imaging apparatus may act on the drum cartridge first, and the separation force is transmitted to the engagement protrusion 800 through the drum cartridge, to achieve the purpose of separating the developing cartridge 1 from the drum cartridge.

As shown in FIG. 49, the conductive assembly 26 is provided independently of the right bracket 2g. Specifically, the conductive assembly 26 is located at an end of the housing 2 close to the right bracket 2g, and the conductive assembly 26 is directly or indirectly connected to the housing 2 and supported by the housing 2, to improve the connection stability the conductive assembly 26 and ensure a conductive effect of the conductive assembly 26. The conductive assembly 26 is located at on a side of the engagement protrusion 800 away from the developing roller 31, and a gap is formed between the conductive assembly 26 and the engagement protrusion 800. It may be understood that the configuration of separating the conductive assembly 26 and the engagement protrusion 800 may avoid the problem that the engagement protrusion 800 affects the conductive assembly 26 when receiving the separation force from the imaging apparatus/the drum cartridge, thus further ensuring the conductive stability of the conductive assembly 26.

Further, still referring to FIG. 49, in the second direction, the engagement protrusion 800 is directly or indirectly connected to the housing 2, and is located between the first bearing 2g2 and the second bearing 2g3. Specifically, in the second direction, the first bearing 2g2 is provided with a first bearing end 2g21 at an end away from the engagement protrusion 800, and the second bearing 2g3 is provided with a second bearing end 2g31 at an end away from the engagement protrusion 800, wherein in the second direction, the engagement protrusion is provided closer to the second bearing end 2g31 than to the first bearing end 2g21.

In some embodiments, in the second direction, a projection of the conductive assembly 26 at least partially overlaps with a projection of the engagement protrusion 800/a projection of the first bearing 2g2/a projection of the second bearing 2g3, which is conducive to the miniaturization of the developing cartridge.

In a variant embodiment of this embodiment, as shown in FIG. 50, the right bracket 2g may include a first bracket 2g4 and a second bracket 2g5 that are connected to each other or provided separately, wherein in the second direction, the first bracket 2g4 is provided away from the developing roller 31, the second bracket 2g5 is located at on a side of the first bracket 2g4 close to the developing roller 31, and the first bearing 2g2 and the second bearing 2g3 are provided at on the second bracket 2g5. It is to be noted that in this embodiment, the conductive assembly 26/the engagement protrusion 800 is still directly or indirectly connected to the housing 2, wherein the first bracket 2g4 is configured to carry at least part of the conductive assembly 26.

Further, as shown in FIG. 50, the engagement protrusion 800 and the first bracket 2g4/the second bracket 2g5 are not in contact, and there is a gap formed between the engagement protrusion 800 and the first bracket 2g4/the second bracket 2g5, thereby avoiding the problem of interference between the engagement protrusion 800 and the first bracket 2g4/the second bracket 2g5 when the imaging apparatus/the drum cartridge applies the separation force to the engagement protrusion 800. Preferably, a spacing between the engagement protrusion 800 and the first bracket 2g4/the second bracket 2g5 is 0.1 mm to 5 mm.

In some embodiments, in the second direction, the projection of the engagement protrusion 800 and the projection of the first bracket 2g4 either do not overlap or at least partially coincide; and in the second direction, the projection of the engagement protrusion 800 and the projection of the second bracket 2g5 either do not overlap or at least partially coincide.

### Embodiment 22

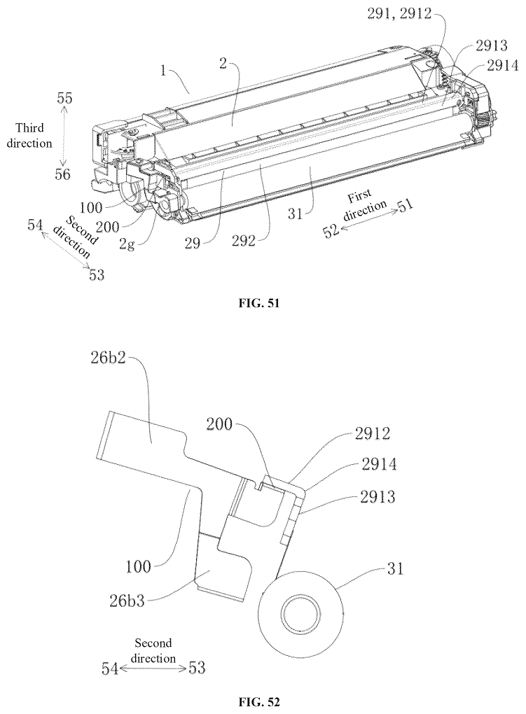

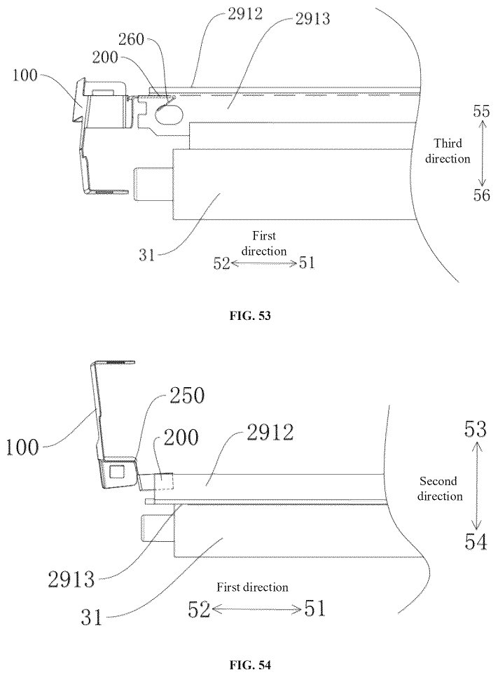

As shown in FIGS. 51 to 54, in the present embodiment, the conductive assembly is supported on the right bracket 2g through a snap-fit structure. The conductive assembly includes a conductive member 100 and a conducting member 200. The conductive member 100 and the conducting member 200 may be formed integrally or separately, and the conducting member 200 is electrically connected to the conductive member 100 and the developing regulating member 29. The conductive member 100 receives electric power from the imaging apparatus and is electrically connected to the developing regulating member 29 through the conducting member 200. In the present embodiment, the conductive member 100 and the conducting member 200 are formed integrally, and in the developing cartridge 1, the conductive member 100 and the conducting member 200 are arranged to extend in different directions, respectively. This may increase the overall flexibility of the conductive assembly, make the conductive assembly conform to the housing 2, and achieve miniaturization of the developing cartridge. Specifically, the conductive member 100 is arranged to extend substantially along the second direction, and the conducting member 200 is arranged to extend substantially along the first direction. The conducting member 200 is arranged to extend along the first direction, which may increase the contact area between the conducting member 200 and the fixed body 291.

In the first direction, the projection of the conducting member 200 does not overlap with the projection of the developing regulating member 29. Specifically, the developing regulating member 29 includes a fixed body 291 fixedly connected to the housing 2 and a regulating body 292 provided on the fixed body 291. One end of the conducting member 200 is electrically connected to the conductive member 100, and the other end is electrically connected to the fixed body 291. The fixed body 291 includes a first flat portion 2912, a second flat portion 2913, and a bent portion 2914 connecting the first flat portion 2912 and the second flat portion 2913. When viewed along the first direction, the first flat portion 2912 and the second flat portion 2913 are arranged to extend in different directions, respectively. In the present embodiment, the conducting member 200 is in contact with the inner side of the first flat portion 2912 in the third direction; additionally, in the third direction, the side of the first flat portion 2912 close to the developing roller 31 is in contact with the conducting member 200. The conducting member 200 may also be in contact with the outer side of the first flat portion 2912 in the third direction; additionally, in the third direction, the side of the first flat portion 2912 remote from the developing roller 31 is in contact with the conducting member 200. In the third direction, the inner side of the first flat portion 2912 is the side close to the developing roller 31, the outer side of the first flat portion 2912 is the side remote from the developing roller 31, and the inner side of the first flat portion 2912 is closer to the developing roller 31 than the outer side. In the third direction, the inner side of the first flat portion 2912 is below the outer side.

In some embodiments, the conducting member 200 may also be electrically connected to the inner side or outer side of the bent portion 2914. The inner side of the bent portion 2914 is the bending side; in other words, the side of the bent portion 2914 facing the housing 2 is the inner side, and the other side is the outer side.

In some embodiments, the conducting member 200 may be in contact with the inner side of the second flat portion 2913 in the second direction; or the conducting member 200 may pass through the developing frame 110 to be in contact with the outer side of the second flat portion 2913 in the second direction. In the second direction, the inner side of the first flat portion 2912 is the side remote from the developing roller 31, the outer side of the first flat portion 2912 is the side close to the developing roller 31, and the outer side of the first flat portion 2912 is closer to the developing roller 31 than the inner side. In the second direction, the inner side of the second flat portion 2913 is rearward of the outer side.

In some embodiments, in the second direction or the third direction, at least a part of the conducting member 200 overlaps with the projection of the developing regulating member 29, enabling the conducting member 200 to be in close contact with the developing regulating member 29 to maintain stable electrical connection. Specifically, in the second direction, at least a part of the conducting member 200 overlaps with the projection of the second flat portion 2913. In the third direction, at least a part of the conducting member 200 overlaps with the projection of the first flat portion 2912.

In some embodiments, a bending portion 250 is provided between the conductive member 100 and the conducting member 200, and the bending portion 250 is used to avoid other components, enabling the conducting member 200 and the conductive member 100 to be provided at predetermined positions.

In some embodiments, at least a part of the conducting member 200 is provided between the developing regulating member 29 and the housing 2, and the conducting member 200 is provided with an elastic portion 260. The elastic portion 260 has a tendency to move away from the conducting member 200, and the elastic portion 260 abuts against the housing 2, so that the conducting member 200 maintains a tendency to move toward the developing regulating member 29, ensuring good electrical contact between the conducting member 200 and the developing regulating member 29. It may be understood that the elastic portion 260 may be integrally formed with or separately provided from the conducting member 200. The elastic portion 260 may also abut against other components, as long as it may ensure good electrical contact between the conducting member 200 and the developing regulating member 29.

In some embodiments, the conducting member 200 is electrically connected to the developing regulating member 29 through the elastic portion 260, and the conducting member 200 abuts against the housing 2, so that the elastic portion 260 maintains a tendency to move toward the developing regulating member 29, ensuring good electrical contact between the elastic portion 260 and the developing regulating member 29.

In some embodiments, the conductive assembly includes a developing roller power input portion 26b2 and a powder feeding roller power input portion 26b3, where the developing roller power input portion 26b2 is configured to engage with the second power output member 102 to receive electric power output by the second power output member 102, and the powder feeding roller power input portion 26b3 is configured to engage with the first power output member 101 to receive electric power output by the first power output member 101. The developing roller power input portion 26b2 and the powder feeding roller power input portion 26b3 are integrally provided, and both may supply power to the developing regulating member 29. When the second power output member 102 or the first power output member 101 is damaged, the developing regulating member 29 may still receive electric power, and the developing cartridge may work normally.

What is claimed is:

1. A developing cartridge comprising:
a housing configured to extend along a first direction;
a driving force receiving member provided at one end of the developing cartridge; and
a developing roller being located at the housing in a rotatable manner, with a rotation axis parallel to the first direction;
wherein the developing cartridge further comprises:
a developing regulating member fixedly mounted on the housing; and
a conductive assembly for receiving electric power from an imaging apparatus and transmitting it to the developing regulating member;
wherein the developing roller comprises a developing roller shaft and a developing layer, the developing layer being farther from the rotation axis of the developing roller than a circumferential surface of the developing roller shaft;
wherein the conductive assembly is not electrically connected to the developing roller shaft;
the conductive assembly comprises a conductive member and a conducting member, the conducting member electrically connecting the conductive member and the developing regulating member; and
the conducting member and the developing regulating member do not overlap in the first direction.

2. The developing cartridge according to claim 1, wherein projections of the conductive assembly and the developing regulating member do not overlap in the first direction.

3. The developing cartridge according to claim 1, wherein the developing regulating member comprises a fixed body fixedly connected to the housing and a regulating body provided on the fixed body, and the conducting member has one end electrically connected to the conductive member and the other end electrically connected to the fixed body.

4. The developing cartridge according to claim 3, wherein in a second direction intersecting the first direction, a side where the developing roller is located is a front of the developing cartridge, and an opposite side to the developing roller is a rear; the conductive member is configured to extend substantially along the second direction, and the conducting member is configured to extend substantially along the first direction.

5. The developing cartridge according to claim 4, wherein in the second direction, an end of the conducting member for connecting to the fixed body is provided on a side of the fixed body away from the regulating body.

6. The developing cartridge according to claim 4, wherein the fixed body comprises a second flat portion fixedly connected to the regulating body, and in the second direction, the conducting member is configured to contact an inner side of the second flat portion.

7. The developing cartridge according to claim 4, wherein a third direction of the developing cartridge intersects both the first direction and the second direction, with one end of the third direction pointing upward of the developing cartridge and the other end pointing downward; in the third direction, the conducting member is provided above the fixed body.

8. The developing cartridge according to claim 6, wherein the fixed body further comprises a first flat portion and a bent portion connecting the first flat portion and the second flat portion; in the third direction, the conducting member is configured to contact an outer side of the first flat portion.

9. The developing cartridge according to claim 8, wherein the first flat portion and the second flat portion are provided at a right angle.

10. The developing cartridge according to claim 7, wherein in the second direction or the third direction, at least a part of the conducting member overlaps with a projection of the developing regulating member.

11. The developing cartridge according to claim 1, wherein the conductive member and the conducting member are provided as separate components, and an end of the conducting member for connecting to the fixed body has a bending part.

12. The developing cartridge according to claim 1, wherein the conducting member is provided with a bending portion and the bending portion is connected to the conductive member.

13. The developing cartridge according to claim 1, wherein at least a part of the conducting member is provided between the developing regulating member and the housing, and the conducting member is provided with an elastic portion that abuts against the housing.

14. The developing cartridge according to claim 1, wherein the developing roller shaft is configured as an insulating shaft body.

15. The developing cartridge according to claim 1, wherein the developing layer comprises an insulating layer and a conductive layer, the insulating layer is provided between the developing roller shaft and the conductive layer, and the developing roller shaft is configured as a conductive shaft.

16. The developing cartridge according to claim 15, wherein the insulating layer is configured as an insulating coating sprayed on a radially outer surface of the developing roller shaft or on a radially inner side of the conductive layer, and the developing roller shaft is configured as a metal shaft.

17. The developing cartridge according to claim 1, further comprising a powder feeding roller for conveying developer to the developing roller, the powder feeding roller being rotatably mounted in the housing; the conductive assembly is in electrical contact with both the developing regulating member and the powder feeding roller; wherein both the developing regulating member and the powder feeding roller are in contact with the developing layer, and at least one of the developing regulating member and the powder feeding roller supplies electric power to the developing layer.

18. The developing cartridge according to claim 1, further comprising a right bracket for supporting the developing roller, at least a part of the conductive assembly being provided at the right bracket; along the first direction, at least a part of the conductive assembly is flush with or extends beyond a farthest end of the right bracket.

19. The developing cartridge according to claim 18, further comprising an engaging protrusion provided at an end of the housing close to the right bracket for receiving a separating force applied by the imaging apparatus; wherein a gap is formed between the conductive assembly and the engaging protrusion.

20. The developing cartridge according to claim 19, wherein in the second direction, a projection of the conductive assembly at least partially overlaps with a projection of the engaging protrusion.
